(19) United States
(12) Patent Application Publication
(10) Pub. No.: US 2018/0220812 A1
(43) Pub. Date: Aug. 9, 2018

(54) SIGNAGE SYSTEMS AND MERCHANDISING DISPLAY ASSEMBLIES

(71) Applicant: T.M. SHEA PRODUCTS, INC., Troy, MI (US)

(72) Inventor: Thomas M. SHEA, Troy, MI (US)

(21) Appl. No.: 15/423,703

(22) Filed: Feb. 3, 2017

(51) Int. Cl. A47F 5/10; G09F 7/10; G09F 7/18; A47B 96/06; A47F 5/00; A47B 57/40; A47F 5/08; A47F 5/02; A47F 5/05

(52) U.S. Cl. CPC A47F 5/101; G09F 7/10; G09F 7/18; A47B 96/06; A47F 5/0043; A47B 57/406; G09F 23/00; A47F 5/0884; A47F 5/0006; A47F 5/02; A47F 5/05; G09F 2007/1856; A47F 5/0018

(57) ABSTRACT

A shelf bracket for suspending merchandising display structures includes a generally planar main body portion, a proximal end for attachment to a shelf, and a distal end. The distal end is for suspending a merchandising display structure. The distal end defines at least one opening. A first tab extends into a first opening of the at least one opening for engaging a hole in a mounting tab a first merchandising display structure.

### FIELD

The present teachings generally relate to retail signage systems and merchandising display assemblies.

### DISCUSSION

A multitude of product and product categories crowd the aisles and merchandise displays of retail stores. Signage systems can be used to showcase products or product categories, attract attention and provide guidance to different sections of the store. For example, various signage systems are shown and described in commonly owned U.S. Publication No. 2012/0240436, U.S. Publication No. 2012/0240436 is incorporated by reference as if fully disclosed herein.

Merchandising display assemblies can be used to more effectively position merchandise within the store. For example, one known merchandise display assembly is shown and described in commonly owned U.S. Pat. No. 5,957,422. U.S. Pat. No. 5,957,422 is incorporated by reference as if fully disclosed herein.

While existing signage systems and merchandising display assemblies have proven to be satisfactory for their intended purposes, there remains a need for continuous improvement within the relevant art.

### SUMMARY

In accordance with one particular aspect, the present teachings provide various merchandising display assemblies.

In accordance with another particular aspect, the present teachings provide various signage systems.

In accordance with yet another particular aspect, the present teachings provide various merchandising display brackets.

In accordance with yet another particular aspect, the present teachings provide various merchandising support members.

In accordance with still yet another particular aspect, the present teachings provide various ornamental designs for merchandising display assemblies, merchandising display brackets and signage systems.

In one particular application, the present teachings provide a shelf bracket for suspending merchandising display structures. The shelf bracket includes a generally planar main body portion, a proximal end for attachment to a shelf, and a distal end. The distal end is for suspending a merchandising display structure. The distal end defines at least one opening. A first tab extends into a first opening of the at least one opening for engaging a hole in a mounting tab a first merchandising display structure.

In another particular application, the present teachings provide a merchandising display structure including a plurality of boxes and a common axis extending through the plurality of boxes. Each box of the plurality of boxes is independently rotatable about the common axis.

In another particular application, the present teachings provide a merchandising display structure including a panel and a plurality of product holders. The panel defines a plurality of slots. Each product holder including a front side, first and second lateral sides, a closed end, an opposite open end, a rear side, and a tab extending from the rear side. Each tab extends through a respective slot of the plurality of slots.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present invention will become more fully understood from the detailed description and the accompanying drawings, wherein:

FIG. 1A is a perspective view of a bracket assembly for use with a signage system.

FIG. 1B is a left side view of the bracket assembly of FIG. 1A.

FIG. 1C is a right side view of the bracket assembly of FIG. 1A.

FIG. 1D is front view of the bracket assembly of FIG. 1A.

FIG. 1E is rear view of the bracket assembly of FIG. 1A.

FIG. 1F is a top view of the bracket of FIG. 1A.

FIG. 1G is a bottom view of the bracket of FIG. 1A.

FIG. 1H is a perspective view of a left side member of the bracket assembly of FIG. 1A.

FIG. 1I is a perspective view of a right side member of the bracket assembly of FIG. 1A.

FIG. 2A is a perspective view of another bracket assembly for use with a signage system.

FIG. 2B is a left side view of the bracket assembly of FIG. 2A.

FIG. 2C is a right side view of the bracket assembly of FIG. 2A.

FIG. 2D is front view of the bracket assembly of FIG. 2A.

FIG. 2E is rear view of the bracket assembly of FIG. 2A.

FIG. 2F is a top view of the bracket of FIG. 2A.

FIG. 2G is a bottom view of the bracket of FIG. 2A.

FIG. 2H is a perspective view of a left side member of the bracket assembly of FIG. 2A.

FIG. 2I is a perspective view of a right side member of the bracket assembly of FIG. 2A.

FIG. 2J is a perspective view of an overhead signage system incorporating the bracket assembly of FIG. 2A-2I.

FIG. 2K is an exploded perspective view of the signage system of FIG. 2J.

FIG. 3A is a perspective view of another bracket assembly for use with a signage system.

FIG. 3B is a perspective view of a left side member of the bracket assembly of FIG. 3A.

FIG. 3C is a perspective view of a right side member of the bracket assembly of FIG. 3A.

FIG. 4A is a perspective view of another bracket assembly for use with a signage system.

FIG. 4B is a perspective view of a left side member of the bracket assembly of FIG. 4A.

FIG. 4C is a perspective view of a right side member of the bracket assembly of FIG. 4A.

FIG. 5A is a perspective view of another bracket assembly for use with a signage system.

FIG. 5B is a perspective view of a left side member of the bracket assembly of FIG. 5A.

FIG. 5C is a perspective view of a right side member of the bracket assembly of FIG. 5A.

FIG. 6A is a perspective view of another bracket assembly for use with a signage system.

FIG. 6B is a perspective view of a left side member of the bracket assembly of FIG. 6A.

FIG. 6C is a perspective view of a right side member of the bracket assembly of FIG. 6A.

FIG. 7A is a perspective view of another bracket assembly for use with a signage system.

FIG. 7B is a perspective view of a left side member of the bracket assembly of FIG. 7A.

FIG. 7C is a perspective view of a right side member of the bracket assembly of FIG. 7A.

FIG. 7D is a perspective view of an overhead signage system incorporating the bracket assembly of FIGS. 7A-7C.

FIG. 7E is an exploded perspective view of the overhead signage system of FIG. 7D.

FIG. 8A is a perspective view of another bracket assembly for use with a signage system.

FIG. 8B is a perspective view of a left side member of the bracket assembly of FIG. 8A.

FIG. 8C is a perspective view of a right side member of the bracket assembly of FIG. 8A.

FIG. 9A is a perspective view of another bracket assembly for use with a signage system.

FIG. 9B is a perspective view of a left side member of the bracket assembly of FIG. 9A.

FIG. 9C is a perspective view of a right side member of the bracket assembly of FIG. 9A.

FIG. 10A is a perspective view of another bracket assembly for use with a signage system.

FIG. 10B is a perspective view of a left side member of the bracket assembly of FIG. 10A.

FIG. 10C is a perspective view of a right side member of the bracket assembly of FIG. 10A.

FIG. 11A is a perspective view of a self-standing merchandising display in accordance with the present teachings, the self-standing merchandising display shown with shelves and brackets to facilitate the retail display of merchandise.

FIG. 11B is a top view of the self-standing merchandising display of FIG. 11A.

FIG. 11C is a bottom view of the self-standing merchandising display of FIG. 11A.

FIG. 11D is an exploded perspective top view of the self-standing merchandising display of FIG. 11A.

FIG. 11E is an exploded perspective view illustrated alternative arrangements incorporating the teachings of the self-standing merchandising display of FIG. 11A.

FIG. 12A is a perspective view of signage support assembly in accordance with the present teachings.

FIG. 12B is another perspective view of the signage support assembly of FIG. 12A.

FIG. 12C is another perspective view of the signage support assembly of FIG. 12A.

FIG. 12D is a left side view of the signage support assembly of FIG. 12A.

FIG. 12E is a right side view of the signage support assembly of FIG. 12A.

FIG. 12F is a front view of the signage support assembly of FIG. 12A.

FIG. 12G is a rear view of the signage support assembly of FIG. 12A.

FIG. 12H is a top view of the signage support assembly of FIG. 12A.

FIG. 12I is a bottom view of the signage support assembly of FIG. 12A.

FIG. 12J is an environmental view illustrating three signage support assemblies of FIGS. 12A-12I shown attached to uprights of a gondola.

FIG. 12K is an environmental view similar to FIG. 12J, further illustrating signage panels carried by the signage support assemblies.

FIG. 13A is a perspective view of a mounting bracket in accordance with the present teachings, the mounting bracket shown operatively associated with an upright of a gondola.

FIG. 13B is a front view of the mounting bracket of FIG. 13A.

FIG. 13C is a rear view of the mounting bracket of FIG. 13A.

FIG. 13D is a left side view of the mounting bracket of FIG. 13A.

FIG. 13E is a right side view of the mounting bracket of FIG. 13A.

FIG. 13F is a top view of the mounting bracket of FIG. 13A.

FIG. 13G is a bottom view of the mounting bracket of FIG. 13A.

FIG. 13H is another perspective view of the mounting bracket of FIG. 13A, the mounting bracket shown carrying a merchandising display member.

FIG. 13I is a perspective view similar to FIG. 13H, the mounting bracket shown carrying an alternative merchandising display member.

FIG. 14A is a perspective view of an adjustable arm assembly for suspending a merchandising support structure.

FIG. 14B is a right side view of the adjustable arm assembly of FIG. 14A.

FIG. 14C is a left side view of the adjustable arm assembly of FIG. 14A.

FIG. 14D is a front view of the adjustable arm assembly of FIG. 14A.

FIG. 14E is a rear view of the adjustable arm assembly of FIG. 14A.

FIG. 14F is a top view of the adjustable arm assembly of FIG. 14A.

FIG. 14G is a bottom view of the adjustable arm assembly of FIG. 14A.

FIG. 14H is another perspective view of the adjustable arm assembly of FIG. 14A the adjustable arm assembly shown carrying a merchandising display structure.

FIG. 15A is a perspective view of a shelf bracket for suspending a merchandising support structure.

FIG. 15B is a top view of the shelf bracket of FIG. 15A.

FIG. 15C is a bottom view of the shelf bracket of FIG. 15A.

FIG. 15D is a left side view of the shelf bracket of FIG. 15A, it being understood that the right side is a mirror image thereof.

FIG. 15E is a front view of the shelf bracket of FIG. 15A, it being understood that the rear view is a mirror image thereof.

FIG. 15F is a shelf bracket of FIG. 15A shown suspending a pair of merchandising display structures.

FIGS. 16A through 16G are perspective views of additional shelf brackets in accordance with the present teachings.

FIG. 17A is a perspective view of a merchandising display structure in accordance with the present teachings.

FIG. 17B is another perspective view of the merchandising display structure of FIG. 17A.

FIG. 17C is a front view of the merchandising display structure of FIG. 17A.

FIG. 17D is rear view of the merchandising display structure of FIG. 17A.

FIG. 17E is a left side view of the merchandising display structure of FIG. 17A.

FIG. 17F is a right side view of the merchandising display structure of FIG. 17A.

FIG. 17G is top view of the merchandising display structure of FIG. 17A.

FIG. 17H is bottom view of the merchandising display structure of FIG. 17A.

FIG. 17I is a perspective view of another merchandising display structure similar to the merchandising display structure of FIG. 17A.

FIG. 17J is a perspective view of another merchandising display structure similar to the merchandising display structure of FIG. 17A.

FIG. 17K is a perspective view of another merchandising display structure similar to the merchandising display structure of FIG. 17A.

FIG. 17L is a perspective view of another merchandising display structure similar to the merchandising display structure of FIG. 17A.

FIG. 18A is a perspective view of a bin for the display of retail goods in accordance with the present teachings.

FIG. 18B is a perspective view of another bin for the display of retail goods in accordance with the present teachings.

FIG. 18C is a perspective view of another bin for the display of retail goods in accordance with the present teachings.

FIG. 18D is a perspective view of another bin for the display of retail goods in accordance with the present teachings.

FIG. 18E is a perspective view of another bin for the display of retail goods in accordance with the present teachings.

FIG. 19A is perspective view of a merchandising display structure in accordance with the present teachings.

FIG. 19B is a perspective view of one of the product holders of the merchandising display structure of FIG. 19A.

FIG. 19C is another merchandising display structure similar to the merchandising display structure of FIG. 19A.

FIG. 19D is another merchandising display structure similar to the merchandising display structure of FIG. 19A.

FIG. 19E is another merchandising display structure similar to the merchandising display structure of FIG. 19A.

FIG. 19F is another merchandising display structure similar to the merchandising display structure of FIG. 19A.

FIG. 20A is perspective view of a merchandising display structure in accordance with the present teachings.

FIG. 20B is an exploded perspective view of the merchandising display structure of FIG. 20A.

FIG. 21A is perspective view of a merchandising display structure in accordance with the present teachings.

FIG. 21B is an exploded perspective view of the merchandising display structure of FIG. 21A.

FIG. 22 is a perspective view of another merchandising display structure in accordance with the present teachings.

FIG. 23 is a perspective view of another merchandising display structure in accordance with the present teachings.

FIG. 24 is a perspective view of a sign holder in accordance with the present teachings.

FIG. 25A is a perspective view of the sign holder of FIG. 24 shown operatively associated with a plurality of signs and positioned on top of a gondola.

FIG. 25B is a perspective view of the sign holder of FIG. 25A shown receiving a plurality of signs and mounted on a gondola.

FIG. 26A is a perspective view of a sign assembly in accordance with the present teachings.

FIG. 26B is an exploded view of the sign assembly of FIG. 26A.

FIG. 27A is a perspective view of a sign assembly in accordance with the present teachings.

FIG. 27B is another perspective view of the sign assembly of FIG. 27A, the sign assembly shown with first and second mounting members removed for purposes of illustration.

FIG. 27C is a side view of the sign assembly of FIG. 27B.

FIG. 27D is a perspective view of one of the mounting members of FIG. 27A.

FIG. 28A is a perspective view of a shelf-mounted sign holder in accordance with the present teachings, the sign holder shown in a first orientation.

FIG. 28B is another perspective view of sign holder of FIG. 28B, the sign holder shown attached to a shelf in the first orientation and carrying a sign.

FIG. 28C is a perspective view of the shelf-mounted sign holder of FIG. 28A, the sign holder shown in a second orientation.

FIG. 28D is another perspective view of sign holder of FIG. 28A, the sign holder shown attached to a shelf in the second orientation and carrying a sign.

FIG. 29 is a perspective view of another sign holder in accordance with the present teachings, the sign holder shown mounted on an extendable arm and carrying a sign.

FIG. 30A is a perspective view of a merchandising display structure in accordance with the present teachings.

FIG. 30B is an exploded perspective view of the merchandising display structure of FIG. 30A.

FIG. 31 is a perspective view of a sign holder in accordance with the present teachings.

FIG. 32 is a perspective view of another sign holder in accordance with the present teachings.

FIG. 33 is another perspective view of the sign holder of FIG. 31 shown with alternative mounting arms.

FIG. 34 is another perspective view of the sign holder of FIG. 32 shown with an alternative mounting arm.

FIG. 35 is an exploded perspective view of another sign holder assembly in accordance with the present teachings.

FIG. 36 is a perspective view of another sign holder assembly in accordance with the present teachings.

FIG. 37 is an exploded perspective view of another sign holder assembly in accordance with the present teachings.

FIG. 38 is a perspective view of another sign holder assembly in accordance with the present teachings.

FIG. 39 is an exploded perspective view of another sign holder assembly in accordance with the present teachings.

FIG. 40 is a perspective view of the sign holder assembly of FIG. 39.

FIG. 41A is a perspective view of another sign holder assembly in accordance with the present teachings.

FIG. 41B is an exploded perspective view of the sign holder assembly of FIG. 41A.

FIG. 42A is a perspective view of another sign holder assembly in accordance with the present teachings.

FIG. 42B is an exploded perspective view of the sign holder assembly of FIG. 42A.

FIG. 43A is a perspective view of another sign holder in accordance with the present teachings.

FIG. 43B is an exploded perspective view of the sign holder of FIG. 43A.

FIG. 44A is a perspective view of another sign holder assembly in accordance with the present teachings.

FIG. 44B is an exploded perspective view of the sign holder assembly of FIG. 44A.

FIG. 45 is a perspective view of another sign holder in accordance with the present teachings.

FIG. 46 is a perspective view of another sign holder in accordance with the present teachings.

FIG. 47 is a perspective view of another sign holder in accordance with the present teachings.

FIG. 48 is a perspective view of another sign holder in accordance with the present teachings.

FIG. 49 is a perspective view of another sign holder in accordance with the present teachings.

It will be understood that the various embodiments shown throughout the application are drawn to scale. Like reference characters have been used throughout the various views to identify like elements.

### DESCRIPTION OF VARIOUS ASPECTS

The following description is merely exemplary in nature and is in no way intended to limit the invention, its application, or uses.

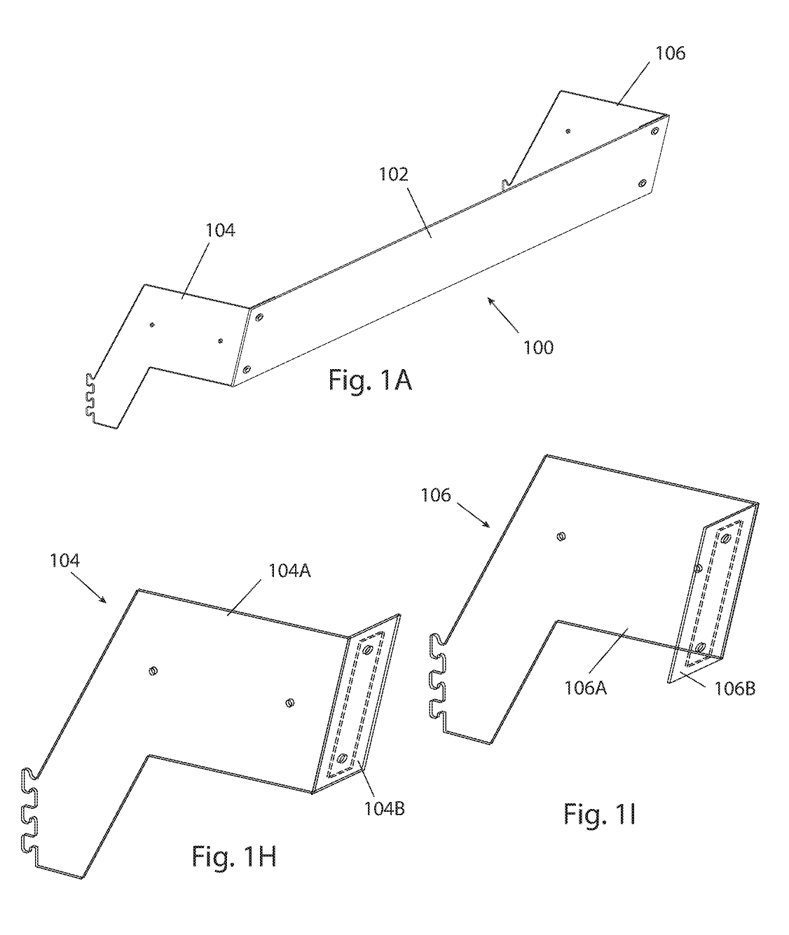

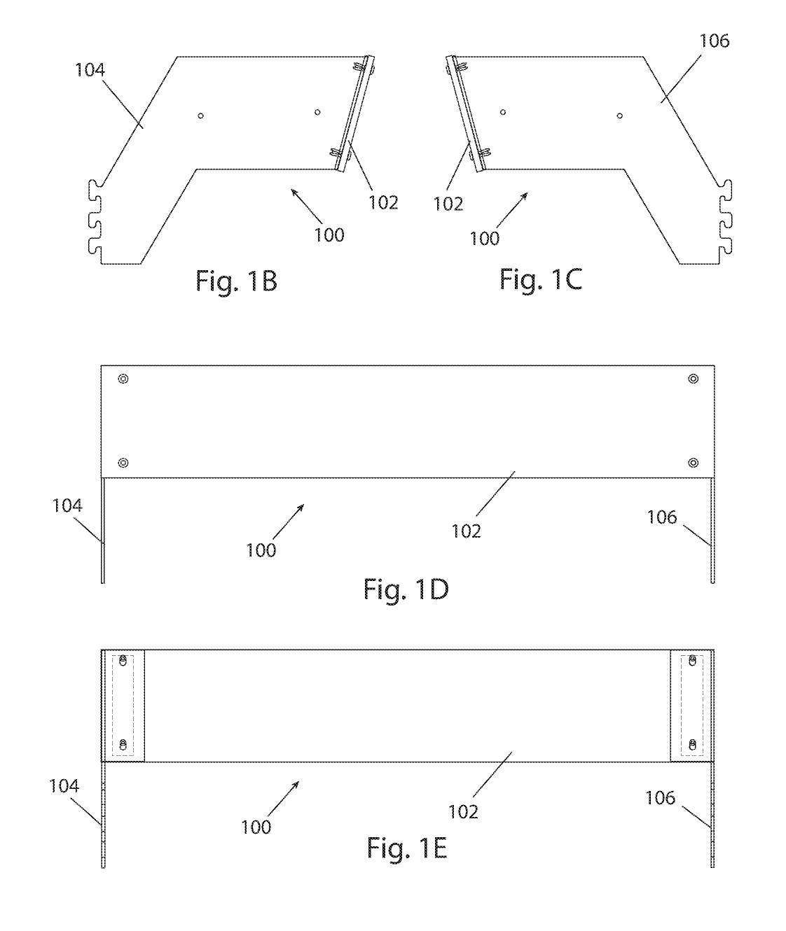

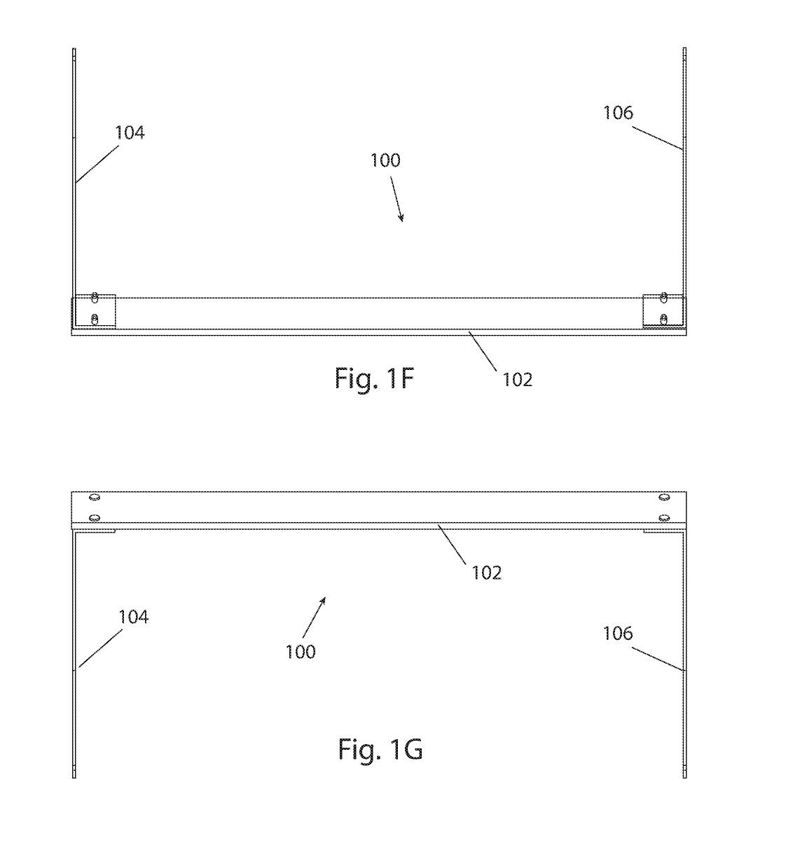

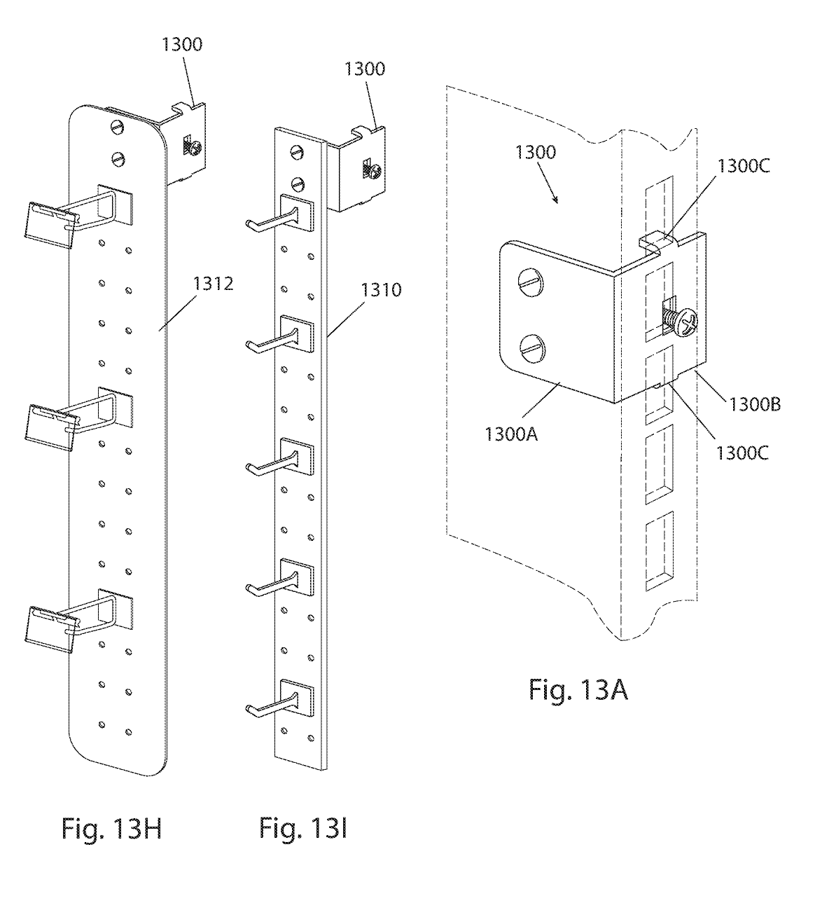

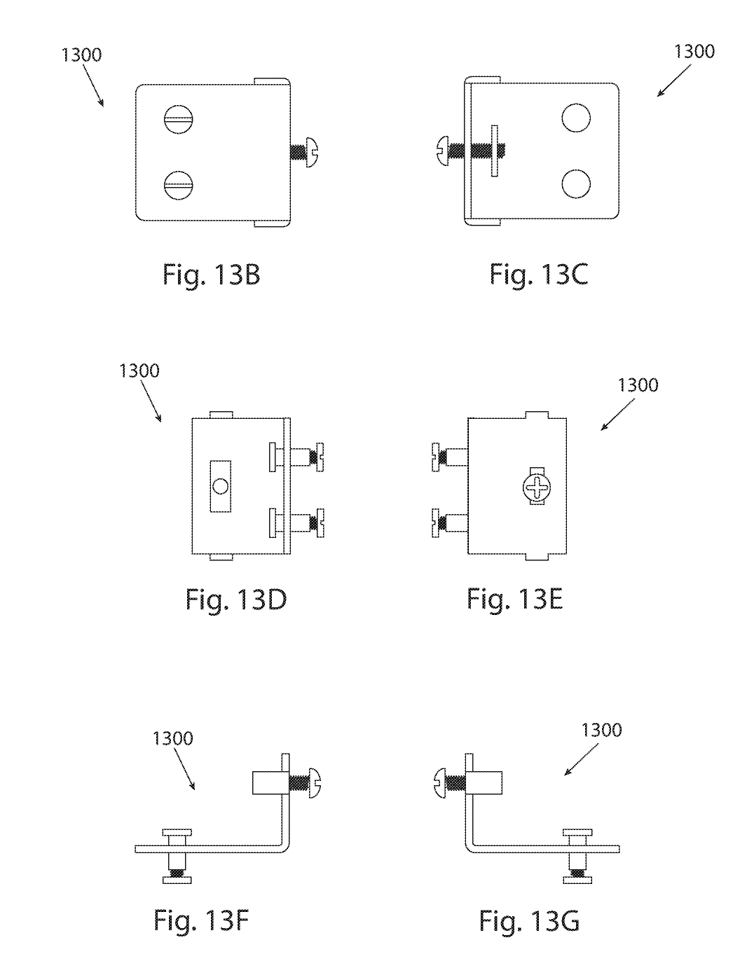

With initial reference to FIGS. 1A-1H, a bracket assembly for signage system in accordance with the present teachings is illustrated and generally identified at reference character 100. The bracket assembly 100 may be used with overhead signage systems such as those shown in FIGS. 13-16 of commonly assigned U.S. Ser. No. 62/313,881, filed on 28 Mar. 2016. U.S. Ser. No. 62/313,881 is hereby incorporated by reference as if fully set forth herein.

As illustrated, the bracket assembly 100 may define a sign holding member having a front member 102 and a pair of side members 104 and 106. The side members 104 and 106 may be mirror images of one another. The front member 102 and the side members 104 and 106 may be constructed of metal or other suitable material. In the embodiment illustrated, the front member 102 may define a planar member. The left and right side members 104 and 106 may include a first planar portion 104A and 106A generally perpendicular to the front member 102. The left and right side members 104 and 106 may additionally include a second planar portion 104B and 106B parallel to the front member 102. The front member 102 may be secured to the left and right side members 104 and 106 with rivets, adhesive or in any other manner well known in the art. The first planar portions 104A and 106B may be unitarily formed to include a mounting geometry for engaging openings in an upright of a gondola, for example. In the embodiment illustrated, the bracket assembly 100 is configured such that the front member 102 angles downwardly. As shown in the side views of FIGS. 1B and 1C, the angling of the front member 102 is facilitated by the shape of the left and right side members 104 and 106. In this regard, the first planar portions 104A and 106A lateral extend further along a top side thereof. Signage may be secured to the bracket assembly 100 in any suitable manner.

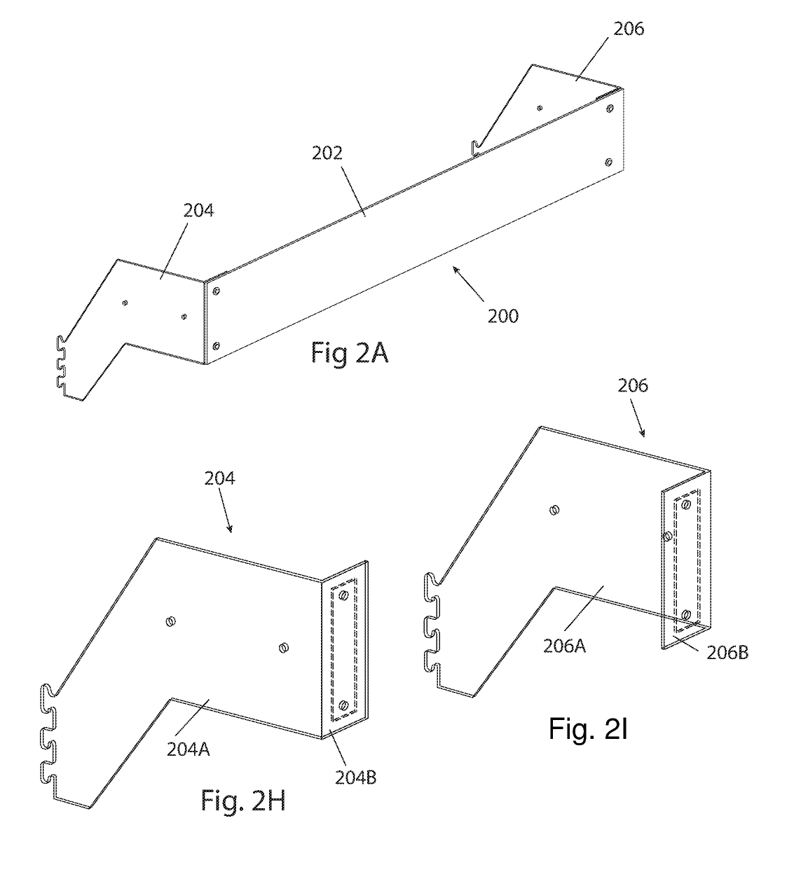

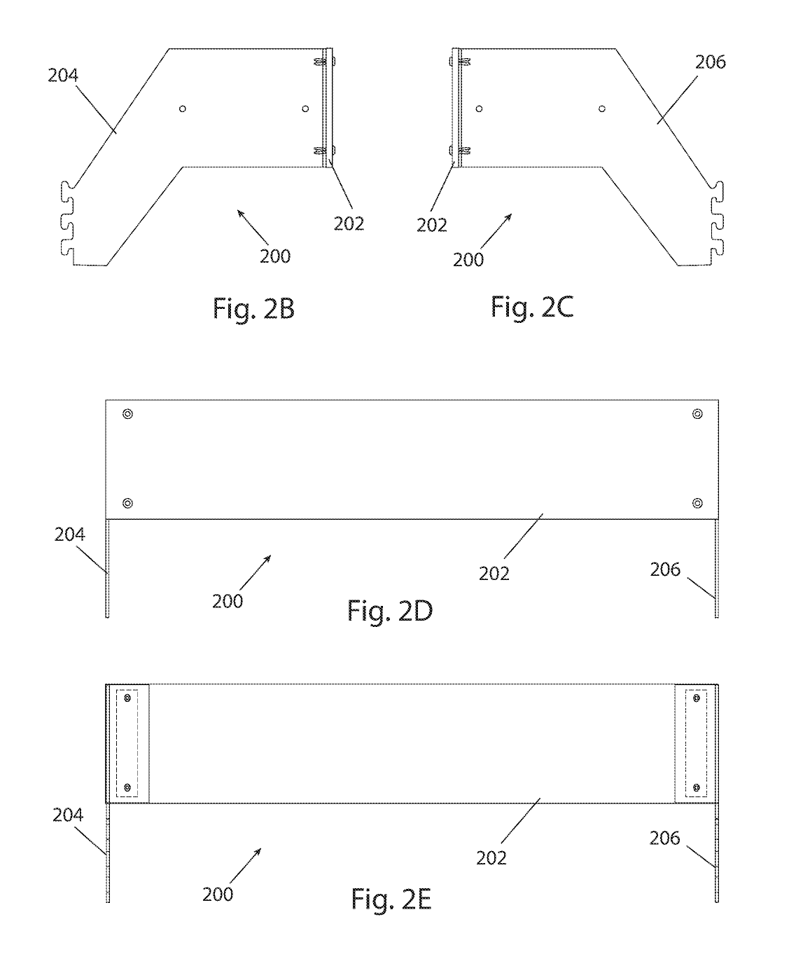

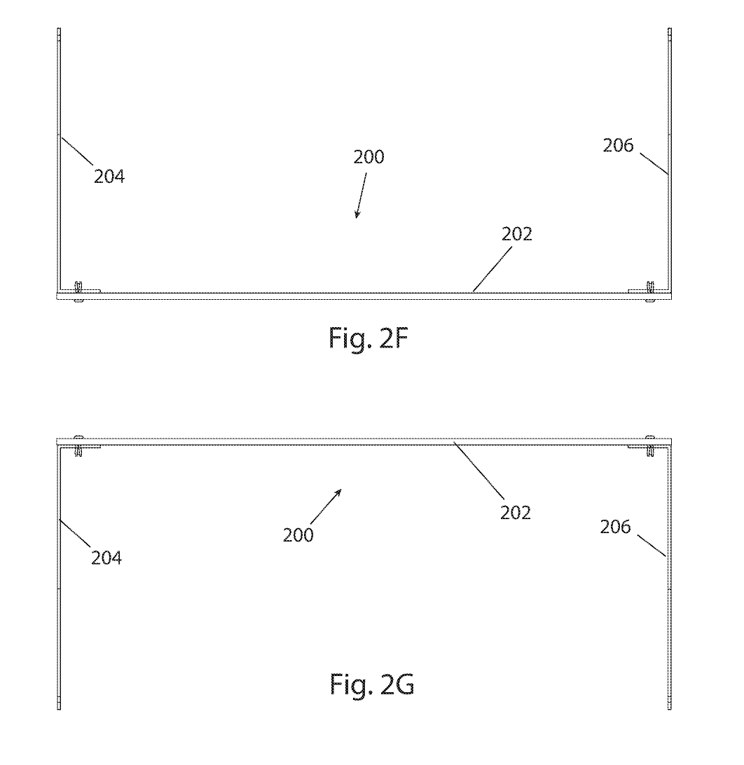

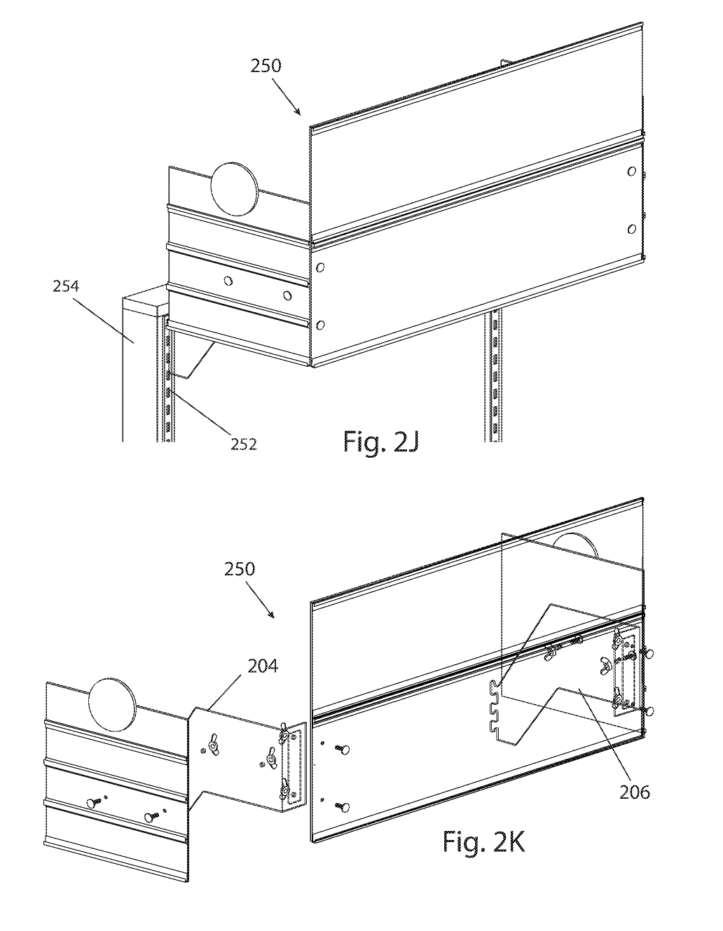

Turning to FIGS. 2A-2H, another the bracket assembly 200 in accordance with the present teachings is illustrated. The bracket assembly 200 differs from the bracket assembly 100 in that a front member 202 is not downwardly angled. The bracket assembly 200 defines a sign holding member having a front member 202 and a pair of side members 204 and 206. The side members 204 and 206 may be mirror images of one another. The front member 202 and the side members 204 and 206 may be constructed of metal or other suitable material. In the embodiment illustrated, the front member 202 may define a planar member. The left and right side members 204 and 206 may include a first planar portion 204A and 206A generally perpendicular to the front member 202. The left and right side members 204 and 206 may additionally include a second planar portion 204B and 206B parallel to the front member 202. The front member 202 may be secured to the left and right side members 204 and 206 with rivets, adhesive or in any other manner well known in the art. The first planar portions 204A and 206B may be unitarily formed to include a mounting geometry for engaging openings in an upright of a gondola, for example. In contrast to the bracket assembly 100, the bracket assembly 200 is configured such that the front member 102 does not angle downwardly. Signage may be secured to the bracket assembly 100 in any suitable manner.

With reference to FIGS. 2J and 2K, an overhead signage system 250 incorporating the bracket assembly 200 of FIG. 2A-2I is illustrated. The signage assembly 250 is shown mounted to an upright 252 of a gondola 254.

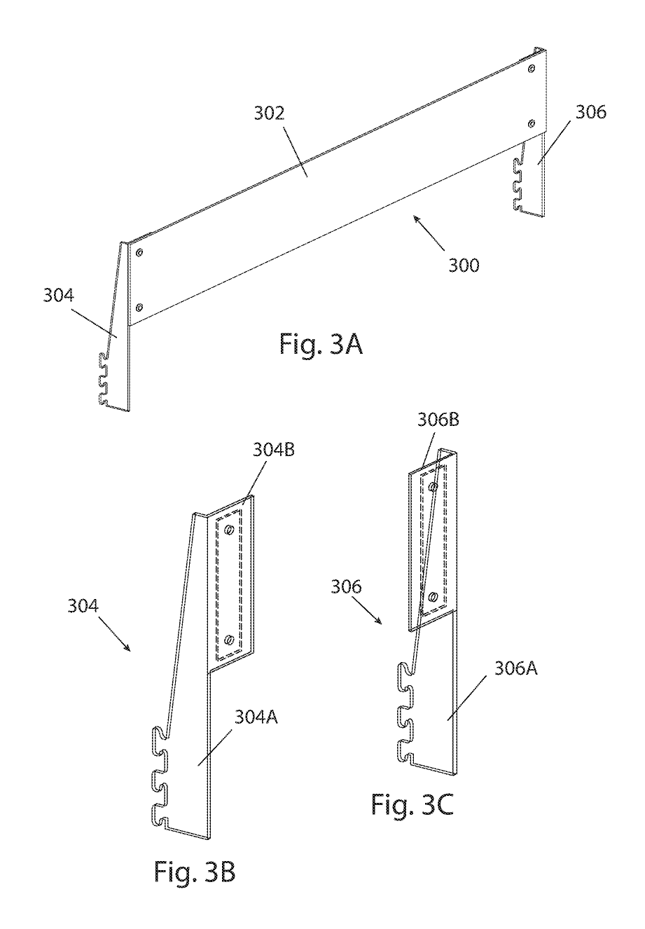

Turning to FIGS. 3A-3C, another the bracket assembly 300 in accordance with the present teachings is illustrated. As with the above embodiments, the bracket assembly 300 defines a sign holding member having a front member 302 and a pair of side members 304 and 306. The side members 304 and 306 may be mirror images of one another. The front member 302 and the side members 304 and 306 may be constructed of metal or other suitable material. In the embodiment illustrated, the front member 302 may define a planar member. The left and right side members 304 and 306 may include a first planar portion 304A and 306A generally perpendicular to the front member 302. The left and right side members 304 and 306 may additionally include a second planar portion 304B and 306B parallel to the front member 302. The front member 302 may be secured to the left and right side members 304 and 306 with rivets, adhesive or in any other manner well known in the art. The first planar portions 304A and 306B may be unitarily formed to include a mounting geometry for engaging openings in an upright of a gondola, for example. Signage may be secured to the bracket assembly 100 in any suitable manner.

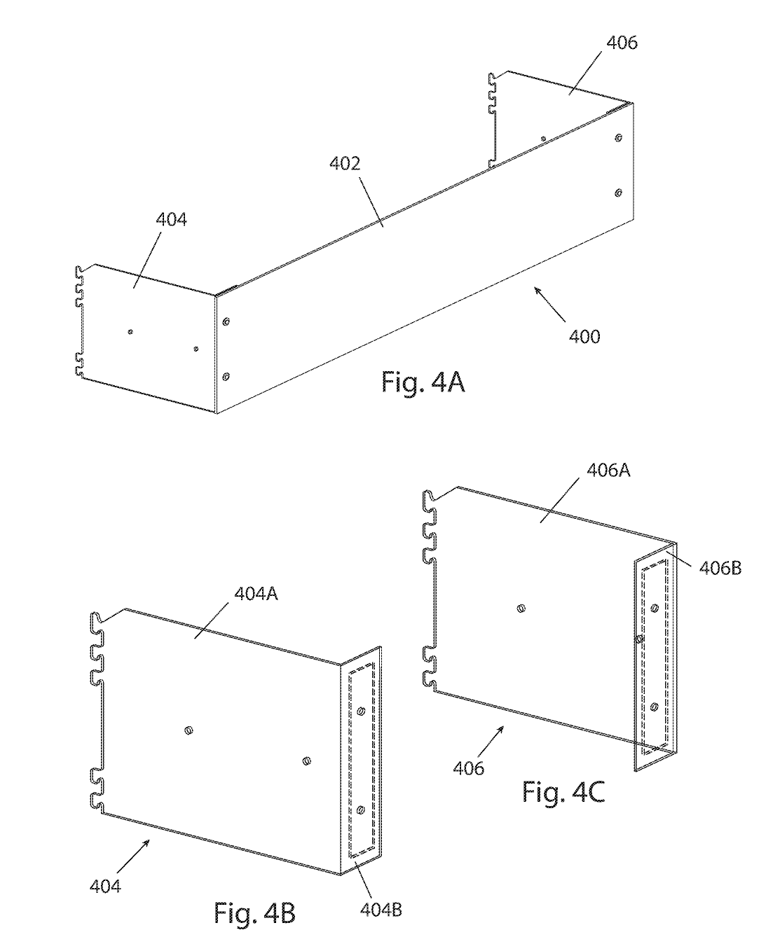

Turning to FIGS. 4A-4C, another the bracket assembly 400 in accordance with the present teachings is illustrated. As with the above embodiments, the bracket assembly 400 defines a sign holding member having a front member 402 and a pair of side members 404 and 406. The side members 404 and 406 may be mirror images of one another. The front member 402 and the side members 404 and 406 may be constructed of metal or other suitable material. In the embodiment illustrated, the front member 402 may define a planar member. The left and right side members 404 and 406 may include a first planar portion 404A and 406A generally perpendicular to the front member 402. The left and right side members 404 and 406 may additionally include a second planar portion 404B and 406B parallel to the front member 402. The front member 402 may be secured to the left and right side members 404 and 406 with rivets, adhesive or in any other manner well known in the art. The first planar portions 404A and 406B may be unitarily formed to include a mounting geometry for engaging openings in an upright of a gondola, for example. Signage may be secured to the bracket assembly 100 in any suitable manner.

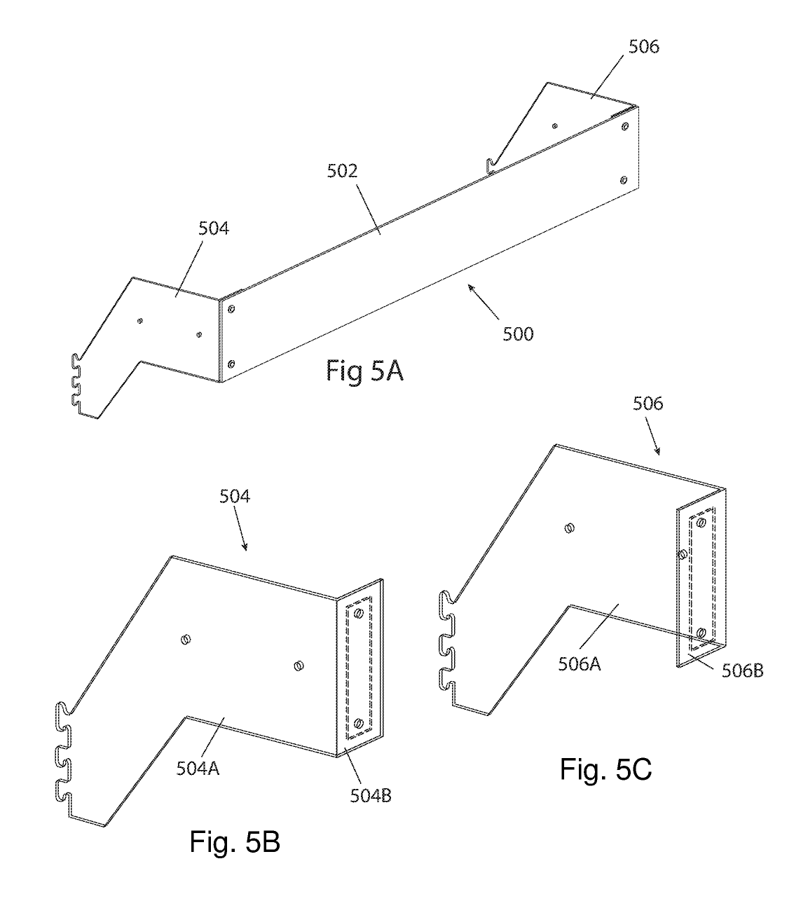

Turning to FIGS. 5A-5C, another the bracket assembly 500 in accordance with the present teachings is illustrated. As with the above embodiments, the bracket assembly 500 defines a sign holding member having a front member 502 and a pair of side members 504 and 506. The side members 504 and 506 may be mirror images of one another. The front member 502 and the side members 504 and 506 may be constructed of metal or other suitable material. In the embodiment illustrated, the front member 502 may define a planar member. The left and right side members 504 and 506 may include a first planar portion 504A and 506A generally perpendicular to the front member 502. The left and right side members 504 and 506 may additionally include a second planar portion 504B and 506B parallel to the front member 502. The front member 502 may be secured to the left and right side members 504 and 506 with rivets, adhesive or in any other manner well known in the art. The first planar portions 504A and 506B may be unitarily formed to include a mounting geometry for engaging openings in an upright of a gondola, for example. Signage may be secured to the bracket assembly 100 in any suitable manner.

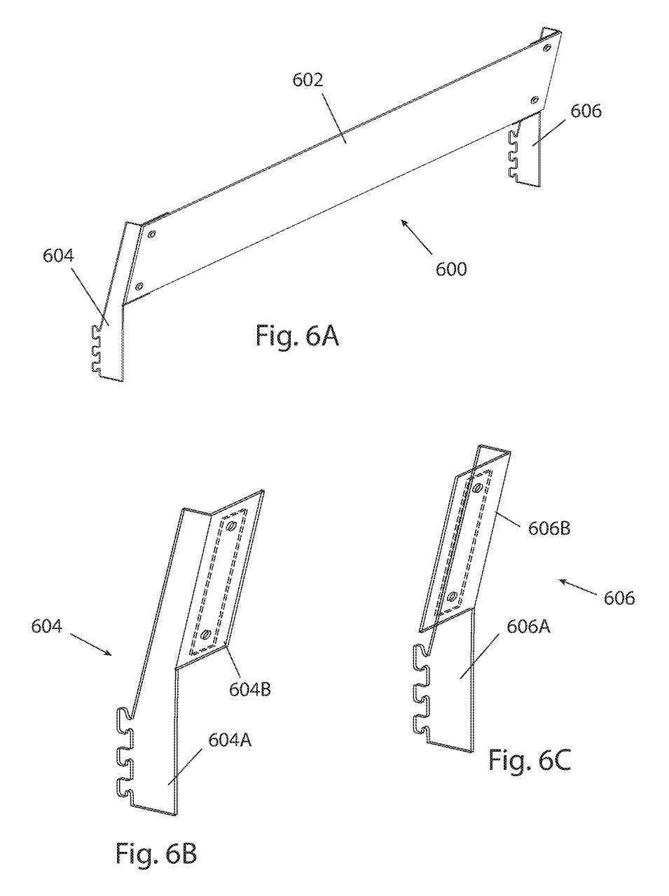

Turning to FIGS. 6A-6C, another the bracket assembly 600 in accordance with the present teachings is illustrated. As with the above embodiments, the bracket assembly 600 defines a sign holding member having a front member 602 and a pair of side members 604 and 606. The side members 604 and 606 may be mirror images of one another. The front member 602 and the side members 604 and 606 may be constructed of metal or other suitable material. In the embodiment illustrated, the front member 602 may define a planar member. The left and right side members 604 and 606 may include a first planar portion 604A and 606A generally perpendicular to the front member 602. The left and right side members 604 and 606 may additionally include a second planar portion 604B and 606B parallel to the front member 602. The front member 602 may be secured to the left and right side members 604 and 606 with rivets, adhesive or in any other manner well known in the art. The first planar portions 604A and 606B may be unitarily formed to include a mounting geometry for engaging openings in an upright of a gondola, for example. Signage may be secured to the bracket assembly 100 in any suitable manner.

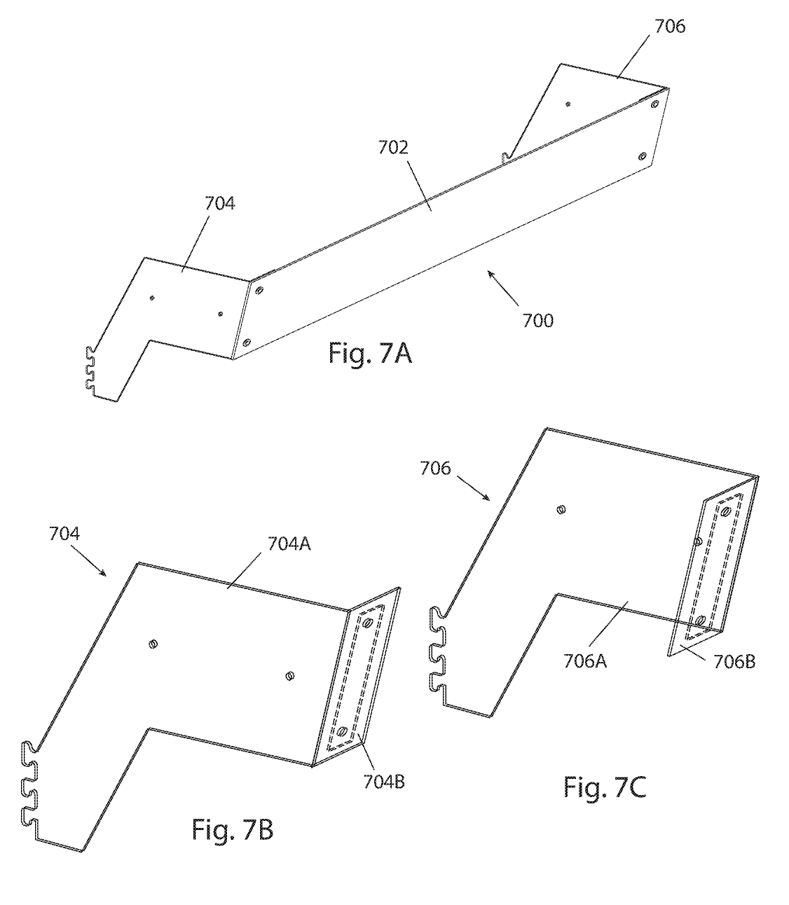

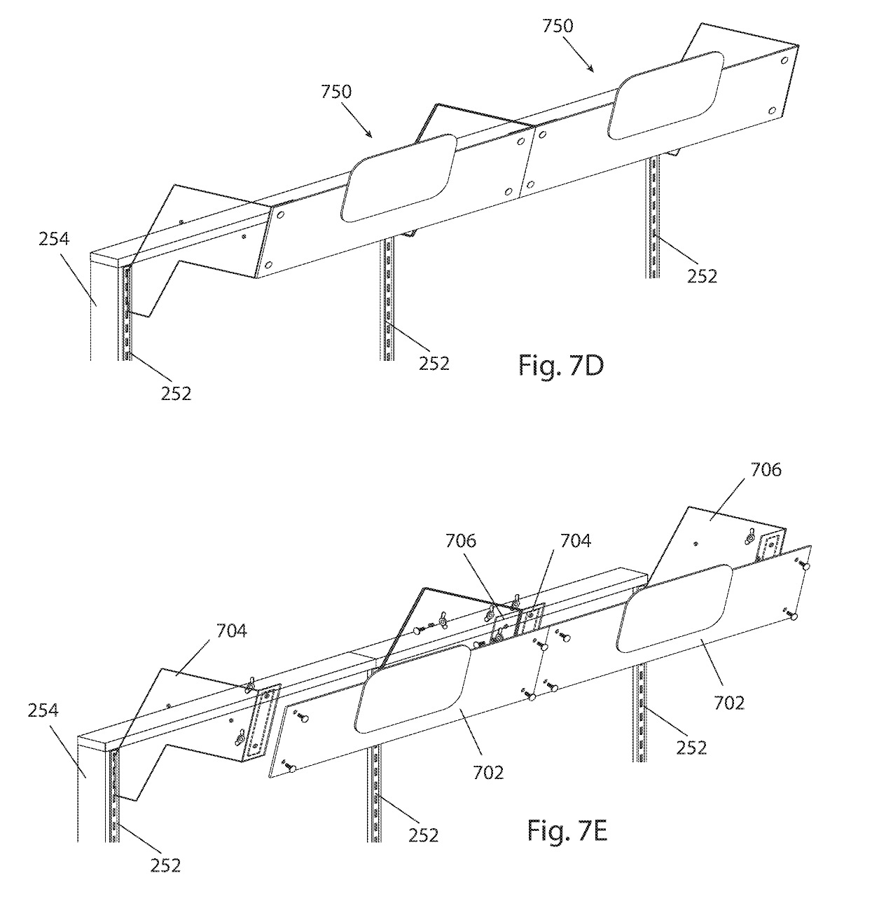

Turning to FIGS. 7A-7C, another the bracket assembly 700 in accordance with the present teachings is illustrated. As with the above embodiments, the bracket assembly 700 defines a sign holding member having a front member 702 and a pair of side members 704 and 706. The side members 704 and 706 may be mirror images of one another. The front member 702 and the side members 704 and 706 may be constructed of metal or other suitable material. In the embodiment illustrated, the front member 702 may define a planar member. The left and right side members 704 and 706 may include a first planar portion 704A and 706A generally perpendicular to the front member 702. The left and right side members 704 and 706 may additionally include a second planar portion 704B and 706B parallel to the front member 702. The front member 702 may be secured to the left and right side members 704 and 706 with rivets, adhesive or in any other manner well known in the art. The first planar portions 704A and 706B may be unitarily formed to include a mounting geometry for engaging openings in an upright of a gondola, for example. Signage may be secured to the bracket assembly 100 in any suitable manner.

With reference to FIGS. 7D and 7E, an overhead signage system 750 incorporating the bracket assembly 700 of FIG. 7A-7C is illustrated. The signage assembly 250 is shown mounted to an upright 252 of a gondola 254.

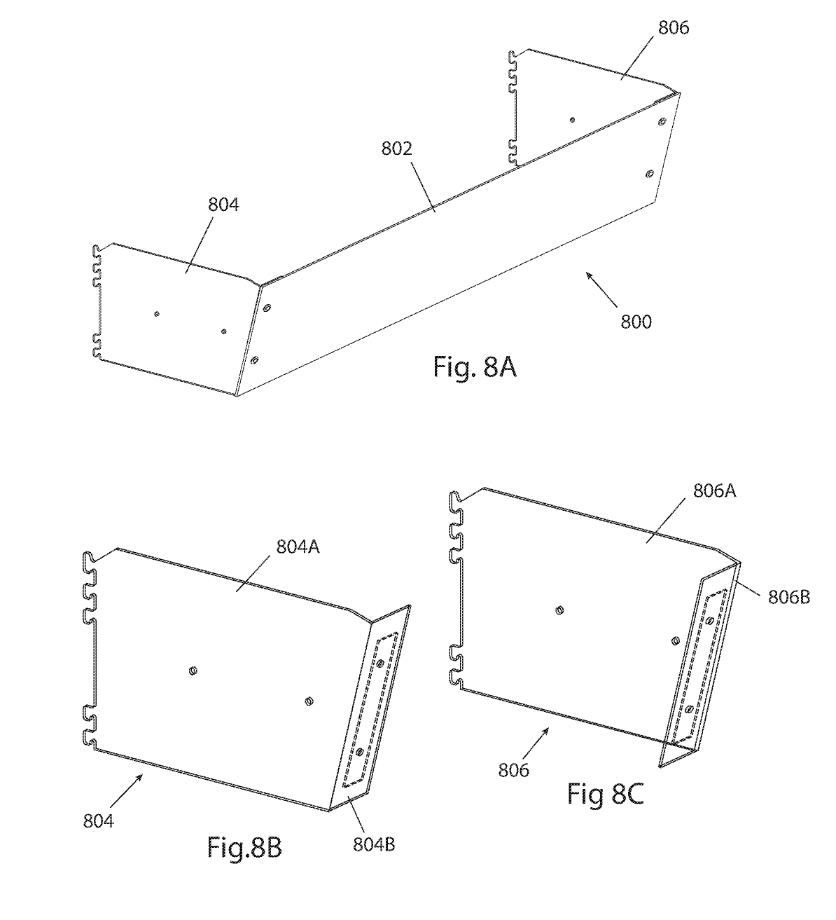

Turning to FIGS. 8A-8C, another the bracket assembly 800 in accordance with the present teachings is illustrated. As with the above embodiments, the bracket assembly 800 defines a sign holding member having a front member 802 and a pair of side members 804 and 806. The side members 804 and 806 may be mirror images of one another. The front member 802 and the side members 804 and 806 may be constructed of metal or other suitable material. In the embodiment illustrated, the front member 802 may define a planar member. The left and right side members 804 and 806 may include a first planar portion 804A and 806A generally perpendicular to the front member 802. The left and right side members 804 and 806 may additionally include a second planar portion 804B and 806B parallel to the front member 802. The front member 802 may be secured to the left and right side members 804 and 806 with rivets, adhesive or in any other manner well known in the art. The first planar portions 804A and 806B may be unitarily formed to include a mounting geometry for engaging openings in an upright of a gondola, for example. Signage may be secured to the bracket assembly 100 in any suitable manner.

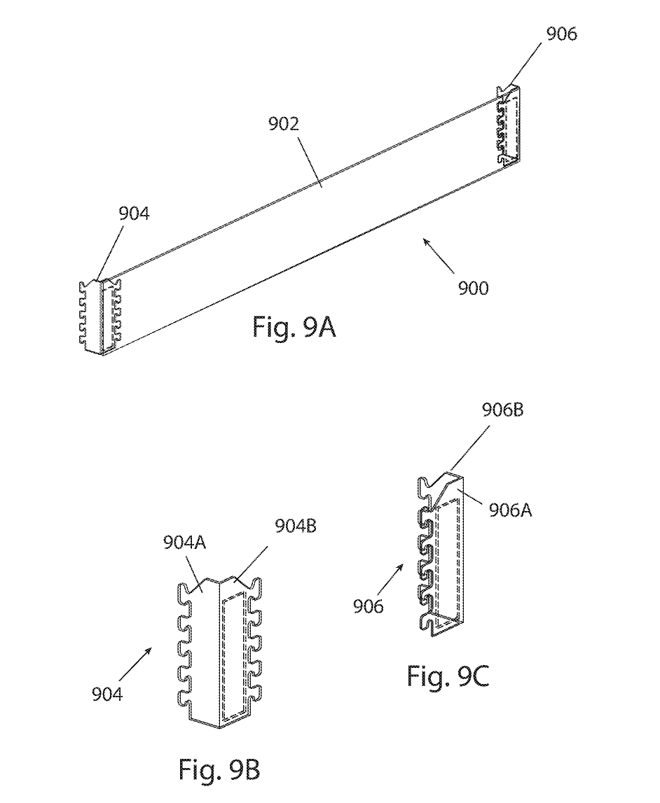

Turning to FIGS. 9A-9C, another the bracket assembly 900 in accordance with the present teachings is illustrated. As with the above embodiments, the bracket assembly 900 defines a sign holding member having a front member 902 and a pair of side members 904 and 906. The side members 904 and 906 may be mirror images of one another. The front member 902 and the side members 904 and 906 may be constructed of metal or other suitable material. In the embodiment illustrated, the front member 902 may define a planar member. The left and right side members 904 and 906 may include a first planar portion 904A and 906A generally perpendicular to the front member 902. The left and right side members 904 and 906 may additionally include a second planar portion 904B and 906B parallel to the front member 902. The front member 902 may be secured to the left and right side members 904 and 906 with rivets, adhesive or in any other manner well known in the art. The first planar portions 904A and 906B may be unitarily formed to include a mounting geometry for engaging openings in an upright of a gondola, for example. Signage may be secured to the bracket assembly 100 in any suitable manner.

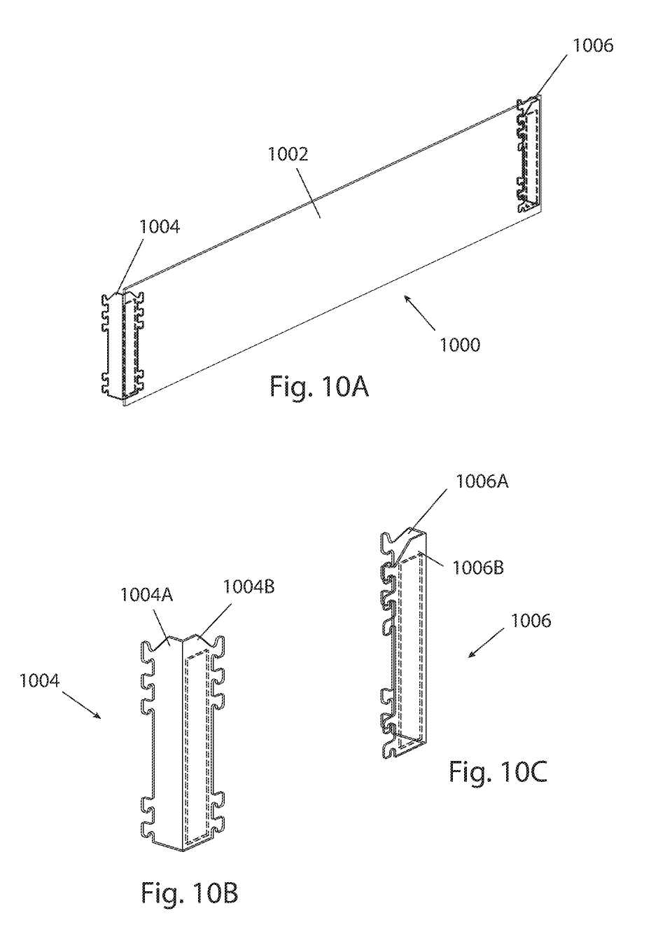

Turning to FIGS. 10A-10C, another the bracket assembly 1000 in accordance with the present teachings is illustrated. As with the above embodiments, the bracket assembly 1000 defines a sign holding member having a front member 1002 and a pair of side members 1004 and 1006. The side members 1004 and 1006 may be mirror images of one another. The front member 1002 and the side members 1004 and 1006 may be constructed of metal or other suitable material. In the embodiment illustrated, the front member 1002 may define a planar member. The left and right side members 1004 and 1006 may include a first planar portion 1004A and 1006A generally perpendicular to the front member 1002. The left and right side members 1004 and 1006 may additionally include a second planar portion 1004B and 1006B parallel to the front member 1002. The front member 1002 may be secured to the left and right side members 1004 and 1006 with rivets, adhesive or in any other manner well known in the art. The first planar portions 1004A and 1006B may be unitarily formed to include a mounting geometry for engaging openings in an upright of a gondola, for example. Signage may be secured to the bracket assembly 100 in any suitable manner.

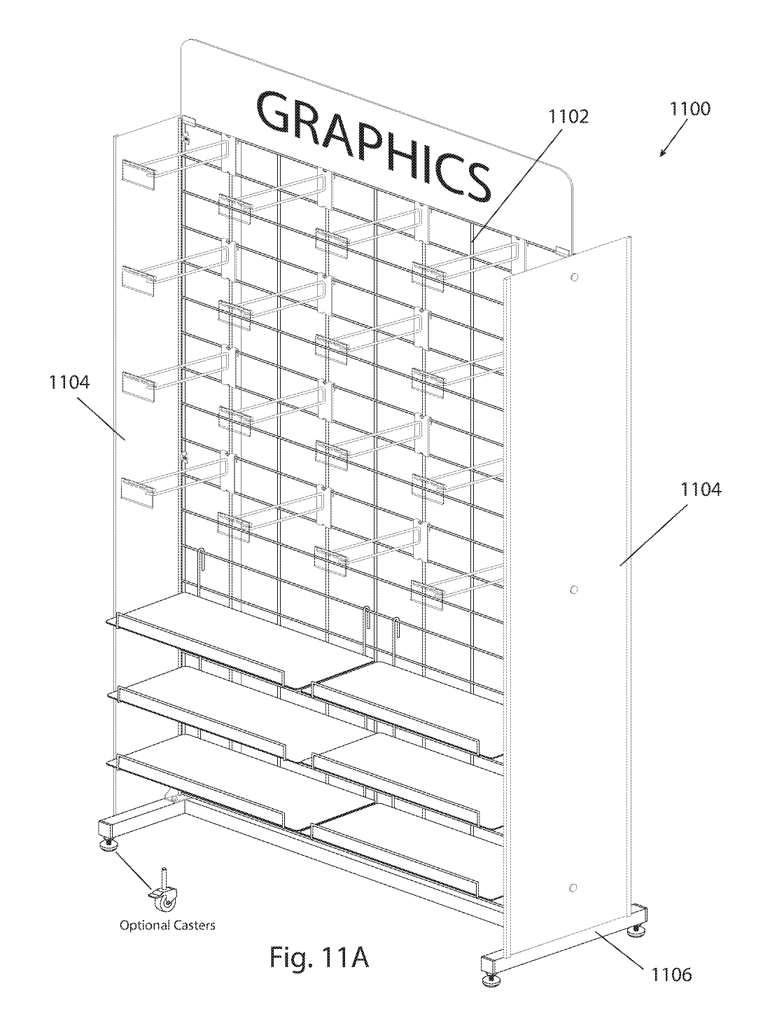

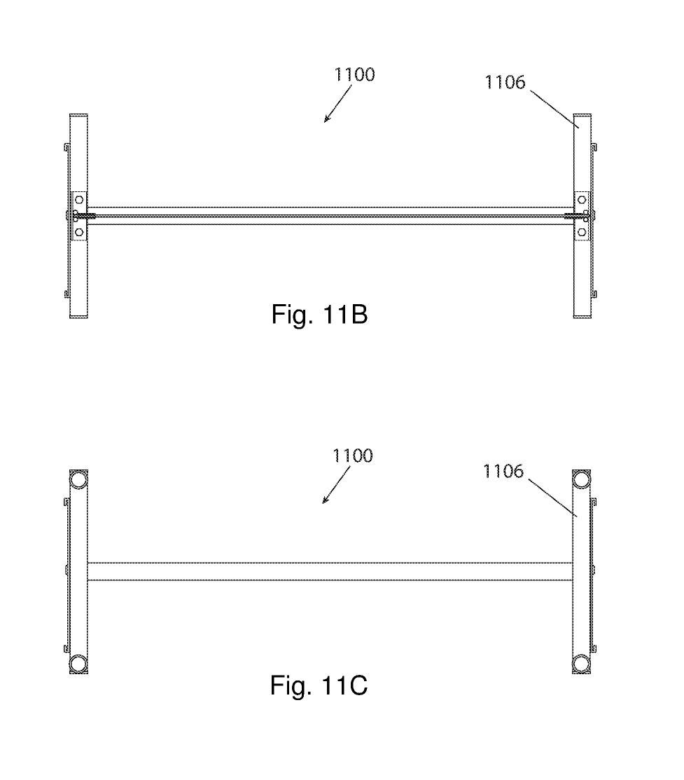

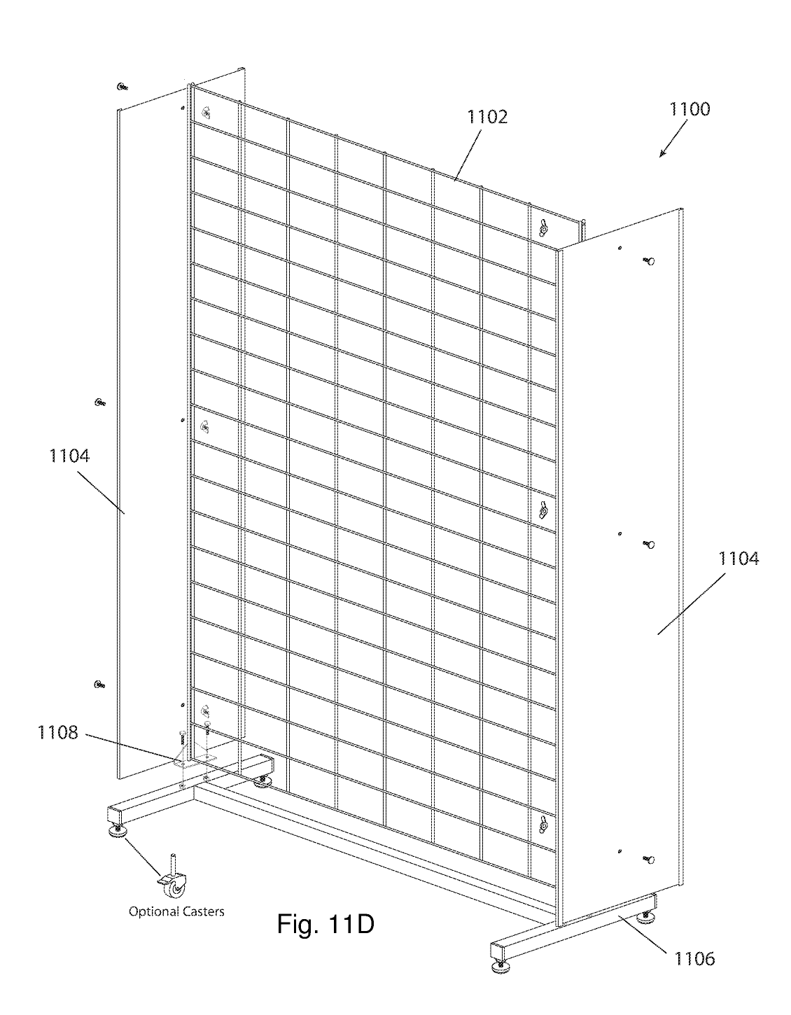

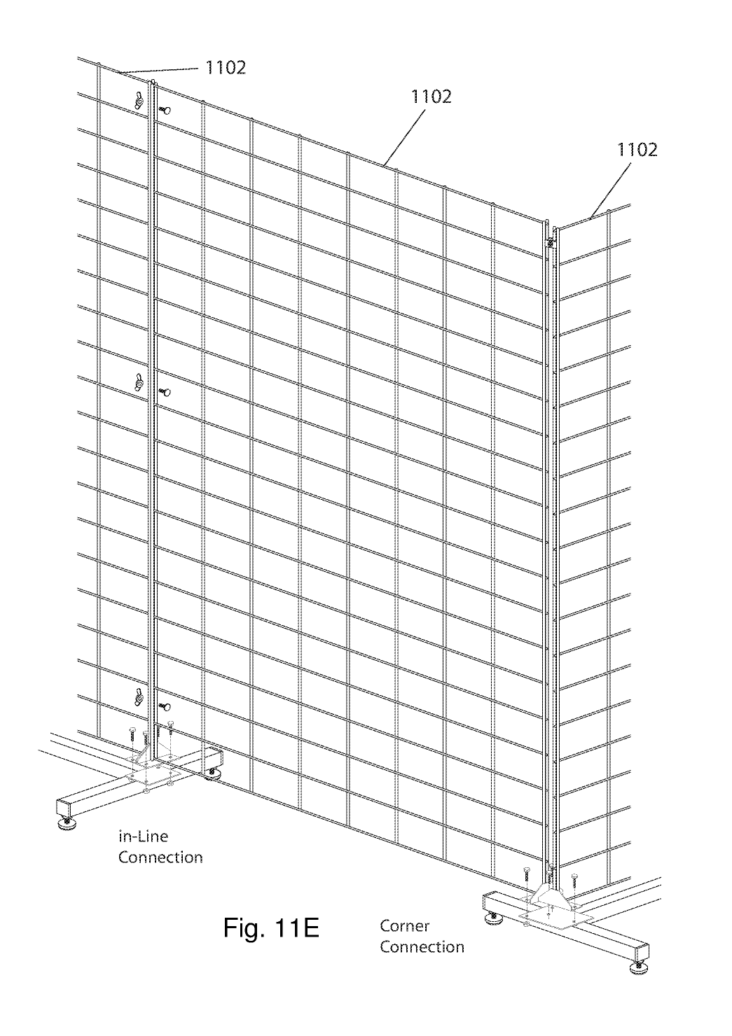

With reference to FIGS. 11A-11F, a self-standing merchandising display in accordance with the present teachings is illustrated and identified at reference character 1100. The merchandising display 1100 is shown to generally include a wire grid 1102, a pair of side panels 1104 and a support frame 1106. The wire grid 1102 may laterally extend between the side panels 1104. As shown in FIG. 11A, the wire grid 1102 may receive brackets and shelves for carrying retail goods.

In the embodiment illustrated, the support frame 1106 may have a generally H-shape with a pair of side members connected by a central member. The side members the central member may be rectangular tubes. The side members and the central members may be welded or otherwise suitably attached to one another. Adjustable support feet or casters may be carried by the support frame 1106 in a conventional manner.

Brackets 1108 may be welding or otherwise secured to lower corners of the wire grid 1102. The brackets 1108 may be attached to the support frame 1106 with fasteners.

The side panels 1104 may slidably receive signage in a known manner. The side panels 1104 may be attached to the wire grid 1102 and/or, the support frame 1106.

With reference to FIG. 11G, alternative mounting arrangements are illustrated. For example, two wire grids 1102 may be interconnected in an in-line relationship. Two wire grids 1102 may also be connected at a corner.

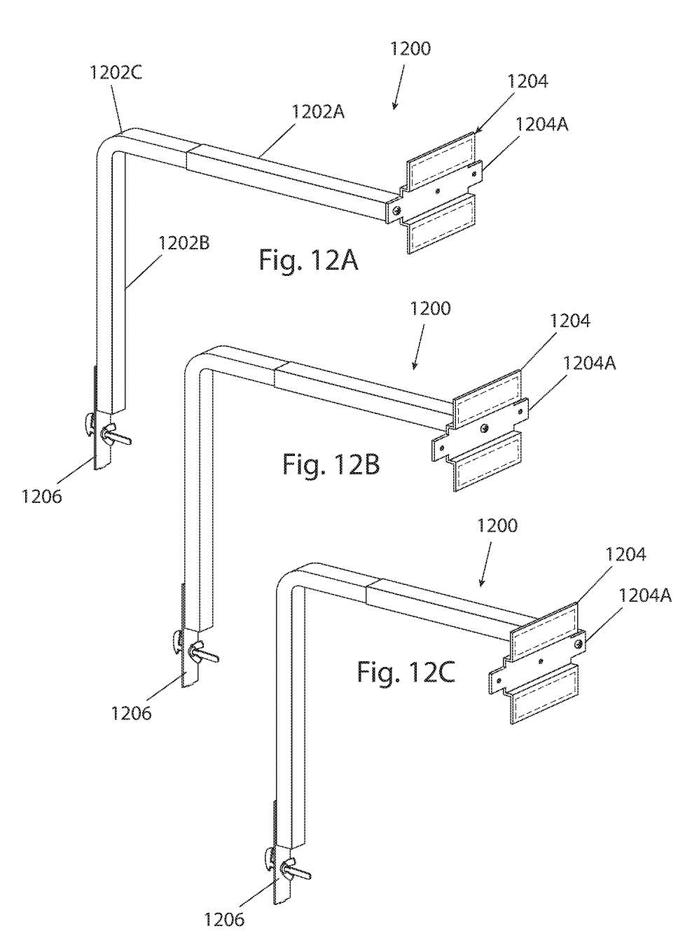

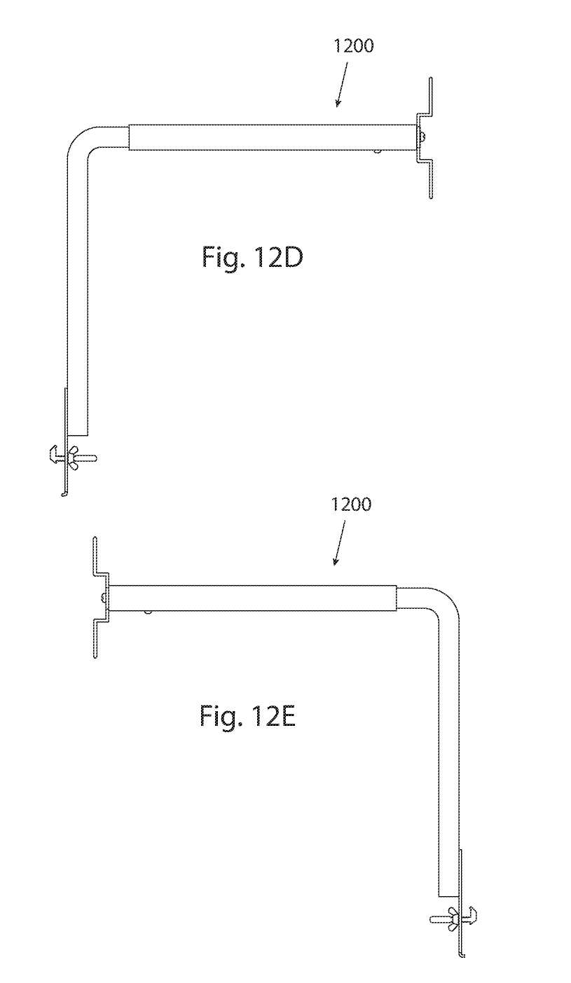

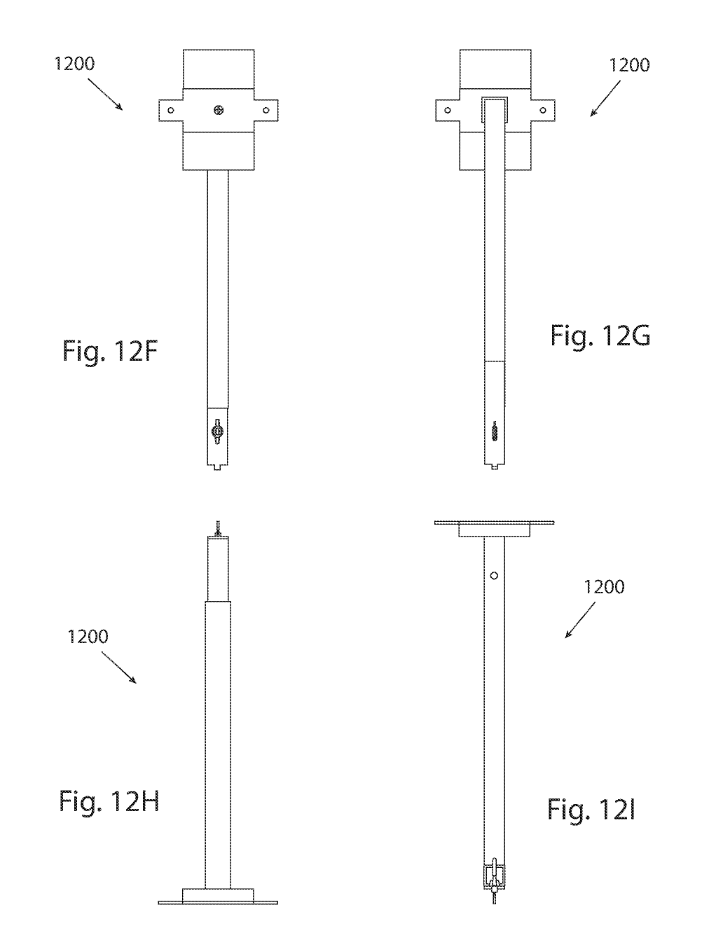

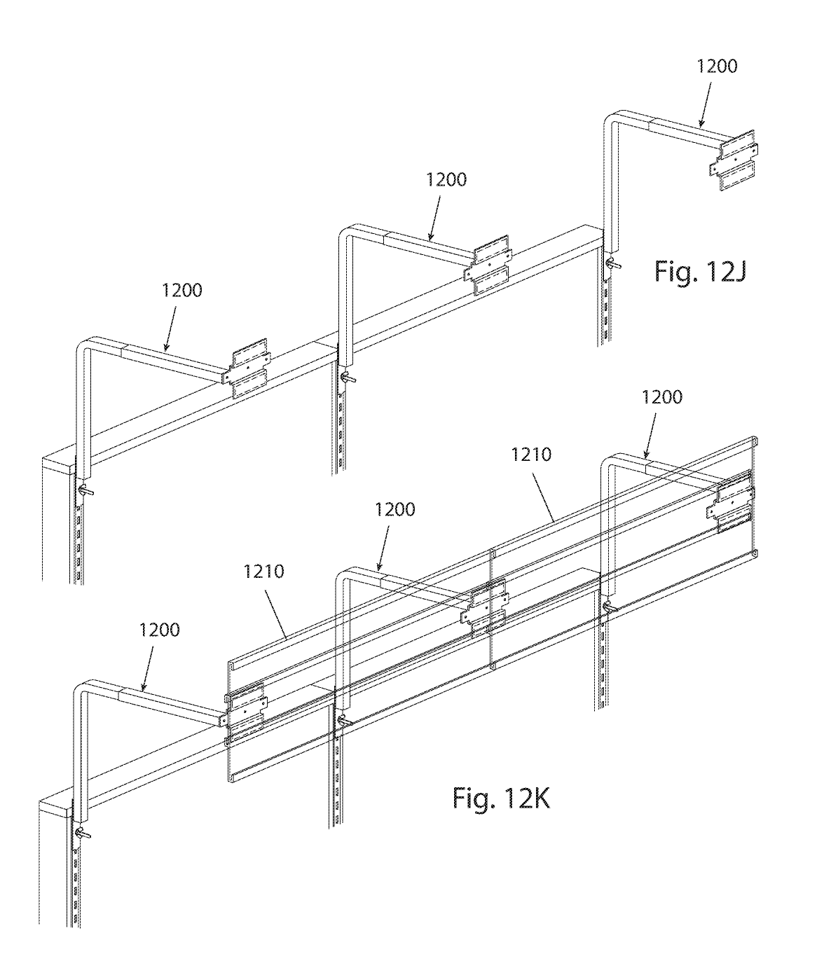

Turning to FIGS. 12A through 12I, a signage support assembly in accordance with the present teachings is illustrated and generally identified at reference character 1200. The signage support assembly may be a bracket assembly 1200 for an overhead sign system. The bracket assembly 1200 may include a main body portion 1202 constructed of a rectangular tube to include a horizontally extending portion 1202A, a vertically extending portion 1202B and a curved intermediate portion 1202C. In the embodiment illustrated, the vertically extending portion 1202B may be unitarily constructed with the curved intermediate portion 1202C. The horizontally extending portion 1202A may be telescopically adjustable relative to the curved intermediate portion 1202C.

The signage assembly 3300 may further include a first mounting member 1204 carried at a free end of the horizontally extending portion 1202A and a second mounting member 1206 carried at a free end of the vertically extending portion 1202B. The first mounting member 1204 may include a central, planar portion 1204A. The central planar portion 1204A may include a plurality of holes for selectively receiving a fastener that engages a corresponding hole in an end of the horizontally extending portion 1202A. In this manner, the first mounting member 1204 may be attached to the main body portion 1202 in distinct positions. A first position is shown in FIG. 12A. A second position is shown in FIG. 12B. A third position is shown in FIG. 12B.

The second mounting member 1206 may be a plate. The plate 1206 may be welded or otherwise suitable attached to the main body portion 1202. Conventional hardware may be carried by the second mounting portion for attaching the bracket assembly 1200 to uprights of a gondola 10.

FIG. 12J is an environmental view illustrating three signage support assemblies 1200 of FIGS. 12A-12I shown attached to uprights of a gondola. FIG. 12K is an environmental view similar to FIG. 12J, further illustrating signage panels 1210 carried by the signage support assemblies 1200.

Turning to FIGS. 13A-13G, a mounting bracket in accordance with the present teachings is illustrated and identified at reference character 1300. The mounting bracket 1300 is particularly adapted for connecting an upright of a gondola with a merchandising display member. As generally illustrated, the mounting bracket 1300 may unitarily constructed of metal or other similar material to include a first generally planar portion 1300A and a second generally planar portion 1300B. The first and second generally planar portions 1300A and 1300B may be generally perpendicular to one another.

In the embodiment illustrated, the first generally planar portion 1300A may be formed to include one or more holes for receiving a corresponding number of fasteners for securing the mounting bracket 1300 to a merchandising display panel. The second generally planar portion 1300B may be formed to include one or more tabs 1300C extending rearwardly therefrom. In the particular embodiment illustrated, the second generally planar portion 1300B includes a first tab 1300 extending from an upper edge and a second tab 1300C extending from a lower edge. It will be understood that only a single tab 1300C is required. The second tab 1300C, however, allows the mounting bracket 1300 to be alternatively oriented (e.g., rotated 180 degrees from that shown in FIG. 13A). The tab 1300C extending from the upper edge extends into an opening of the gondola upright and blocks downward translation of the mounting bracket 1300. The second generally planar side 1300B is further shown to define an opening for receiving a fastener. The fastener may be used to secure the mounting bracket 1300 to the upright to prevent horizontal displacement from the upright.

Turning to FIG. 13H, another perspective view of the mounting bracket 1300 is provided. The mounting bracket 1300 is shown carrying a merchandising display member 1310. FIG. 13I is a perspective view similar to FIG. 13H showing the mounting bracket 1300 carrying an alternative merchandising display member 1312.

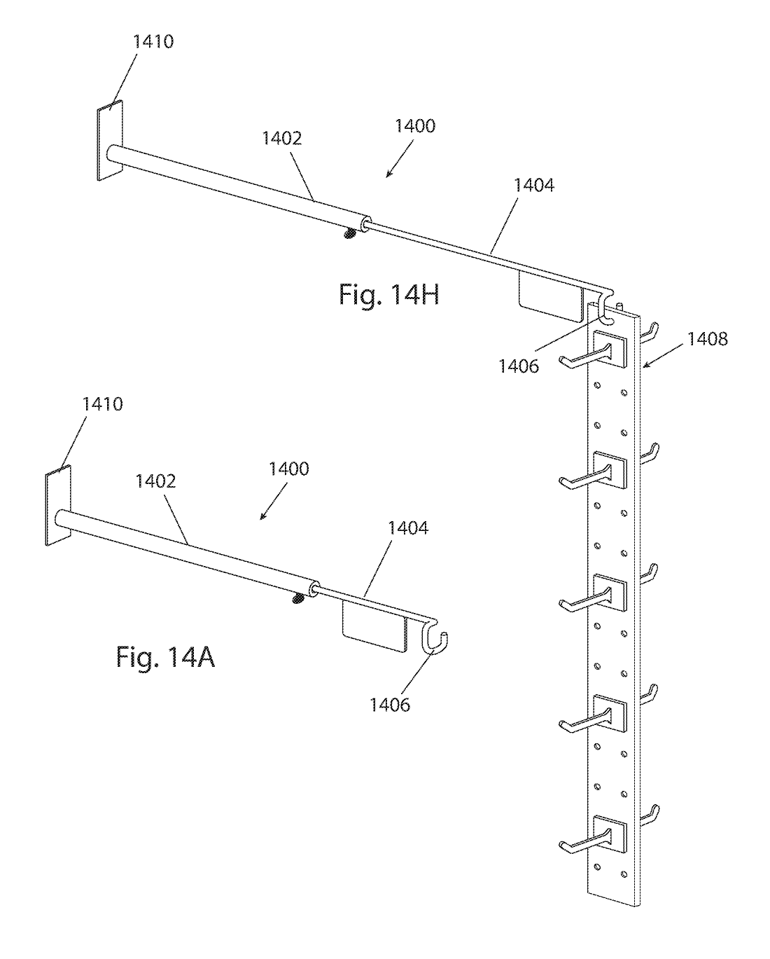

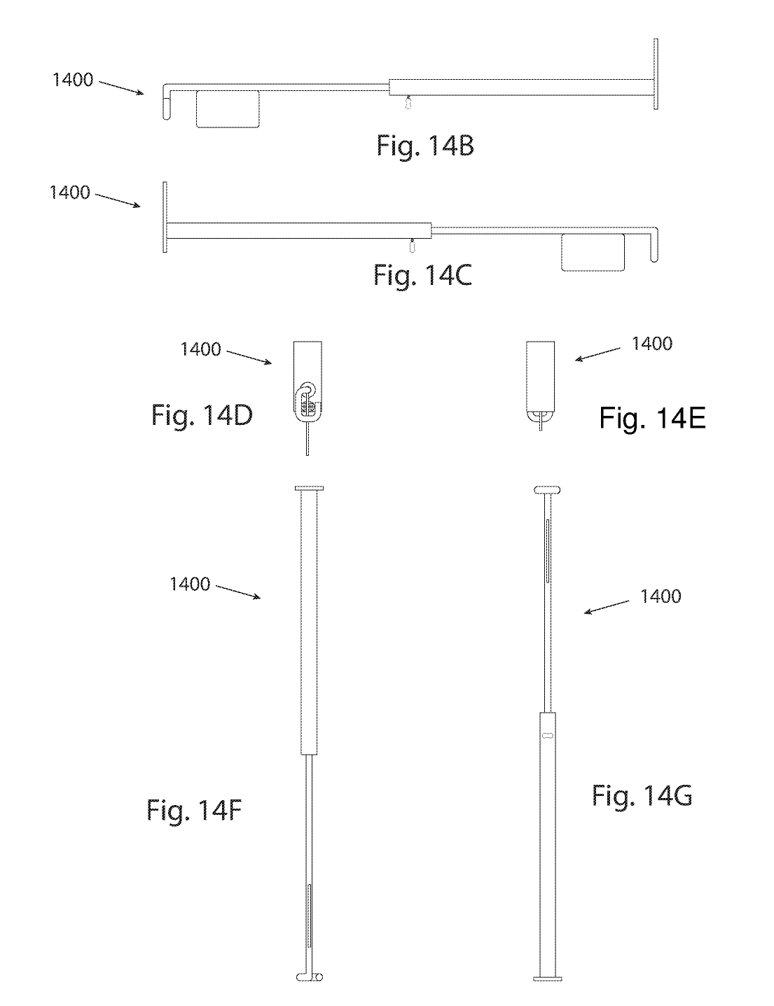

Turning to FIGS. 14A-14H, an adjustable arm assembly in accordance with the present teachings is illustrated and identified at reference character 1400. The adjustable arm assembly is particularly adapted for suspending a merchandising support structure.

The adjustable arm assembly 1400 is illustrated to generally include first and second horizontally extending members 1402 and 1404. The first and second horizontally extending members 1402 and 1404 may be adjustably interconnected. In the embodiment illustrated, the first and second horizontally extending members 1402 and 1404 are telescopically interconnected.

The first member 1402 may be a hollow tube. The second member 1404 may be a wire rod. The wire rod 1404 is shown in a more retracted orientation in FIG. 14A, for example. The wire rod 1404 is shown in a more extended orientation in FIG. 14H, for example. A thumb screw may extend through a hole in the first member 1402 and engage the second member 1404 to lock in a desired telescopic orientation between the first and second horizontally extending members 1402 and 1404. A distal end of the second member 1404 may be unitarily formed to include a hook 1406 for suspending a merchandising display 1408 (see FIG. 14H). A proximal end of the first member 1402 may include a mounting structure 1410. The mounting structure 1410 may vary depending on a desired structure for attachment of the adjustable arm assembly 1400.

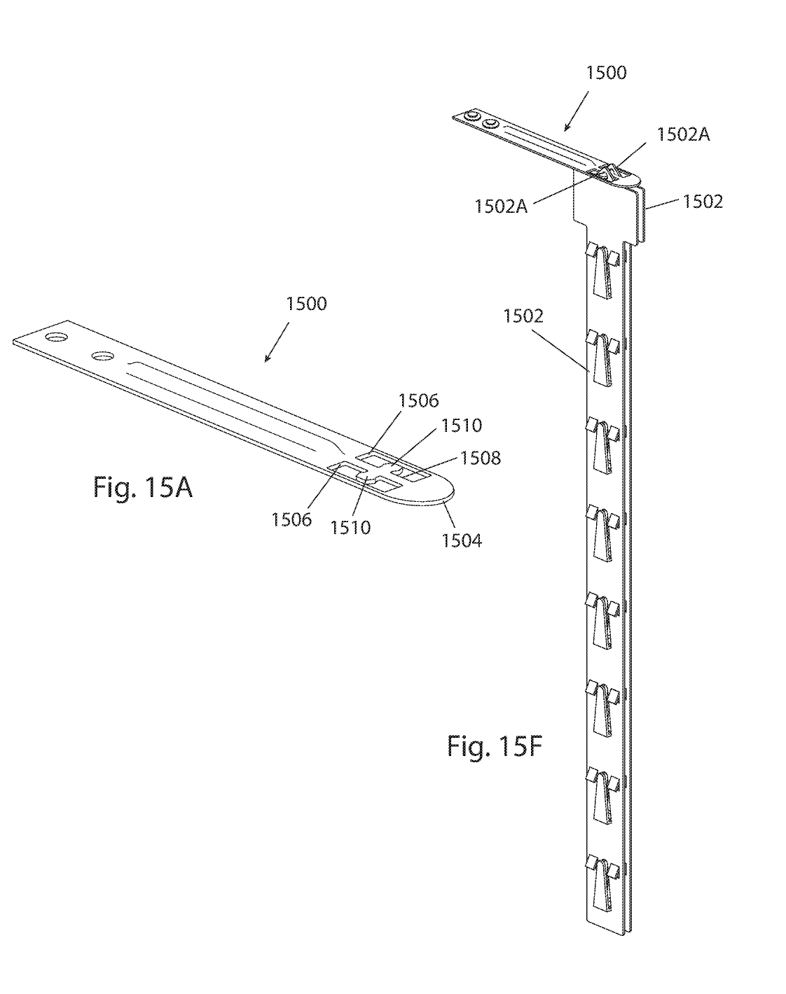

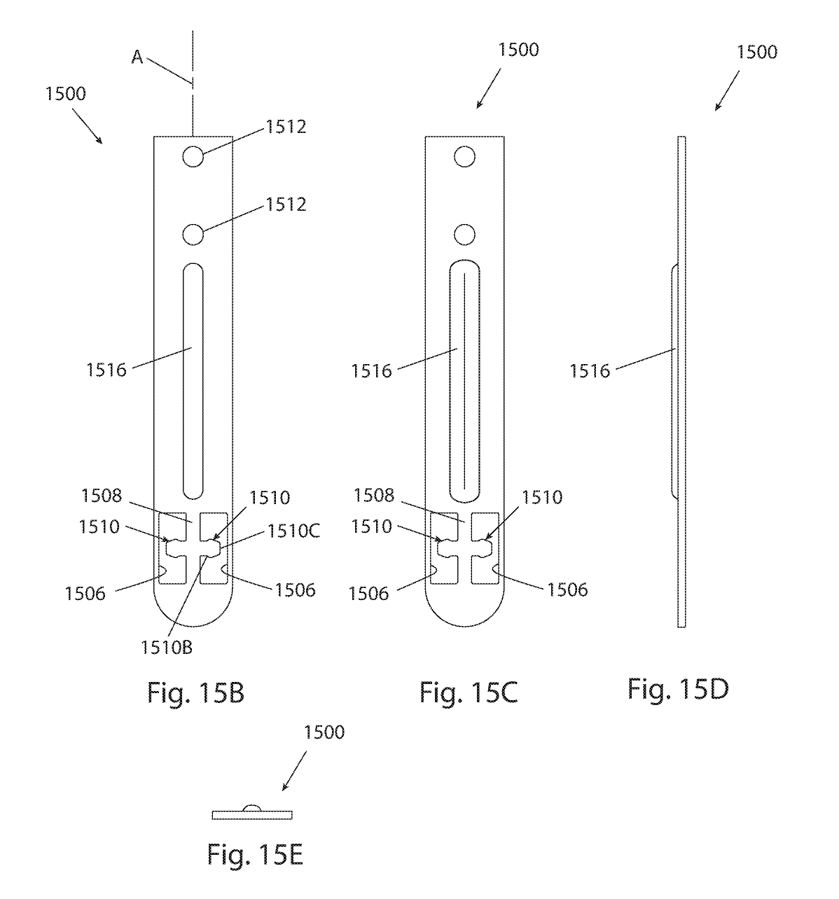

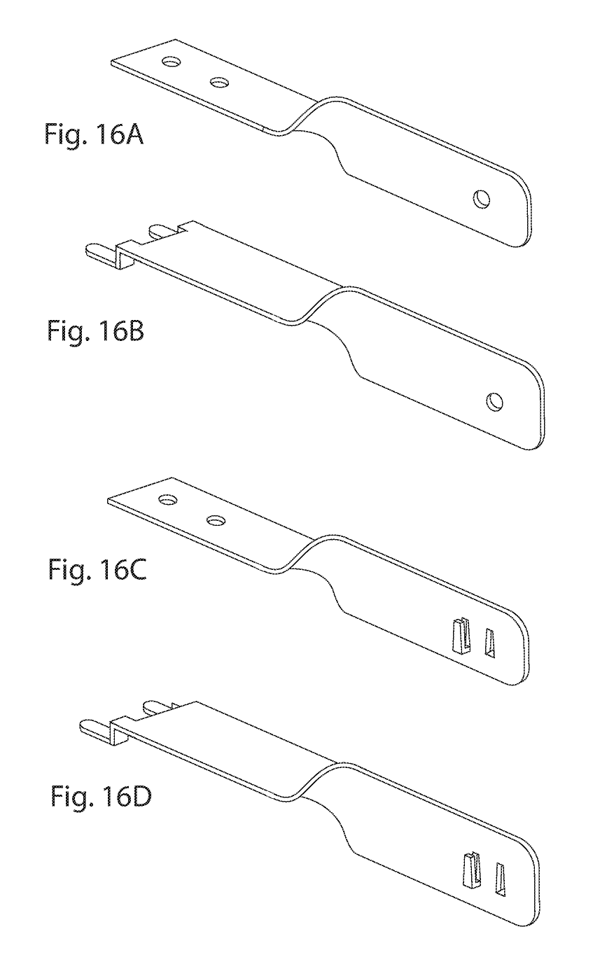

Turning to FIGS. 15A-15F, a shelf bracket for suspending a merchandising support structure in accordance with the present teachings is illustrated and generally identified at reference character 1500. In one particular application, the shelf bracket 1500 may be stamped from metal. Alternatively, however, it will be understood that the shelf bracket 1500 may be formed with an alternative process or with other suitable materials. In FIG. 15F, the shelf bracket 1500 is shown suspending a pair of merchandising display structures 1502.

The shelf bracket 1500 may be generally planar. As illustrated, the shelf bracket may include a rounded distal or forward end 1504. Proximate the distal end 1504, the shelf bracket may be formed to include one or more openings 1506. In the embodiment illustrated, the shelf bracket 1504 is formed to include first and second openings 1506. The first and second openings 1506 may be generally rectangular and parallel to one another. The first and second openings 1506 may be separated by a web 1508. Each opening 1506 may be associated with a tab 1510 that inwardly extends into the opening from the web 1508.

As perhaps best shown in the top and bottom views of FIGS. 15B and 15C, both the tabs 1510 include a reduced width portion 1510A adjacent the web 1508. In the embodiment illustrated, the reduced width portion 1510A may extend perpendicular to a longitudinal axis A of the shelf bracket 1500. As the tabs 1510 further extend from the web 1508, they may include a linearly widen to a maximum width and thereafter linearly taper to a free end 1510C. The free end 1510C is spaced from an opposing side of the opening 1508.

The cooperating merchandising display structures 1502 may include mounting tabs 1502A inserted into respective ones of the openings 1508. In certain applications, the mounting tabs 1502A may include openings that widen in a downward direction. These openings in the mounting tabs 1502A may be triangular in shape. The tabs 1502A may be introduced from an underside of the shelf bracket 1500 between one of the tabs 1510 and the opposing side of the opening 1508. When the opening in the mounting tab 1502A is aligned with the tab 1508, the tab 1508 is inserted into the opening in the mounting tab 1502A. The merchandising display structure 1502 is displaced slightly downwardly such that the narrowing of the opening in the mounting tab 1502A that is now at the height of the tab 1510 has a width that is less than the maximum width of the tab 1510. In this manner, the merchandising display structure 1502 is retained on the tab 1510.

At a proximal end, the shelf bracket 1500 may include or one more holes 1512 for receiving fasteners to attach the shelf bracket 1500 to a shelf. In the embodiment illustrated, the shelf bracket 1500 is formed to include a pair of holes so as to prevent rotation of the shelf bracket 1500. It will be understood, however, that a greater or lesser number of holes may be used within the scope of the present teachings. In one particular application, the shelf bracket 1500 may be attached to the top of a shelf. It will be understood, however, that the shelf bracket 1500 may alternatively be attached to the bottom of a shelf.

A central portion of the shelf bracket 1500 may be formed to include a reinforcing rib 1516. The rib 1516 may extend along a portion of the length of the shelf bracket 1500 and may provide the shelf bracket 1500 with increased strength.

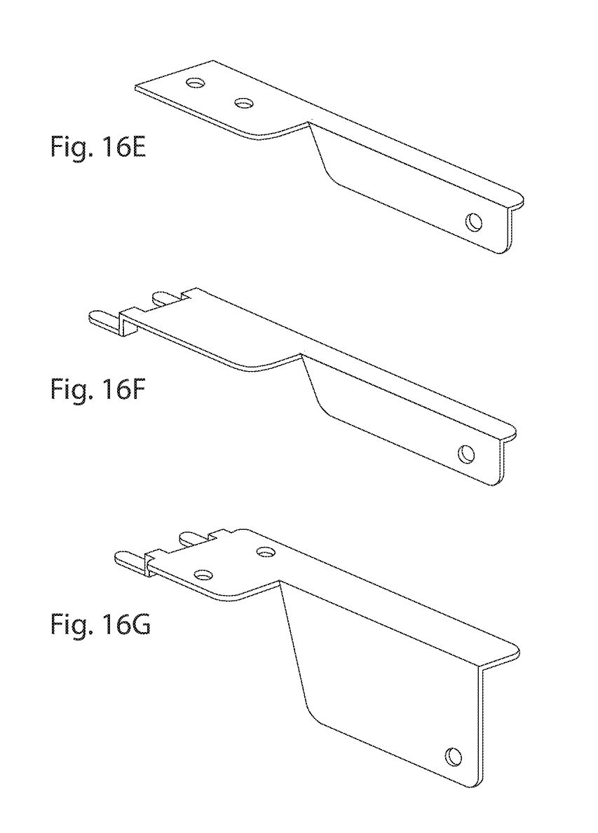

With reference to FIGS. 16A through 16G, illustrated are additional shelf brackets having alternative configurations within the scope of the present teachings.

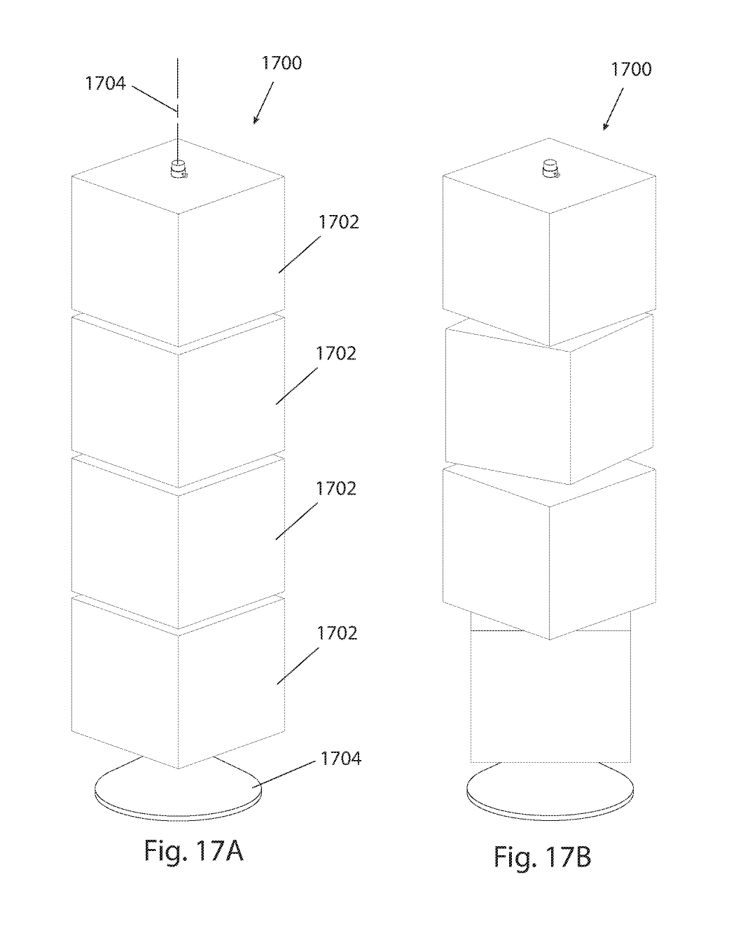

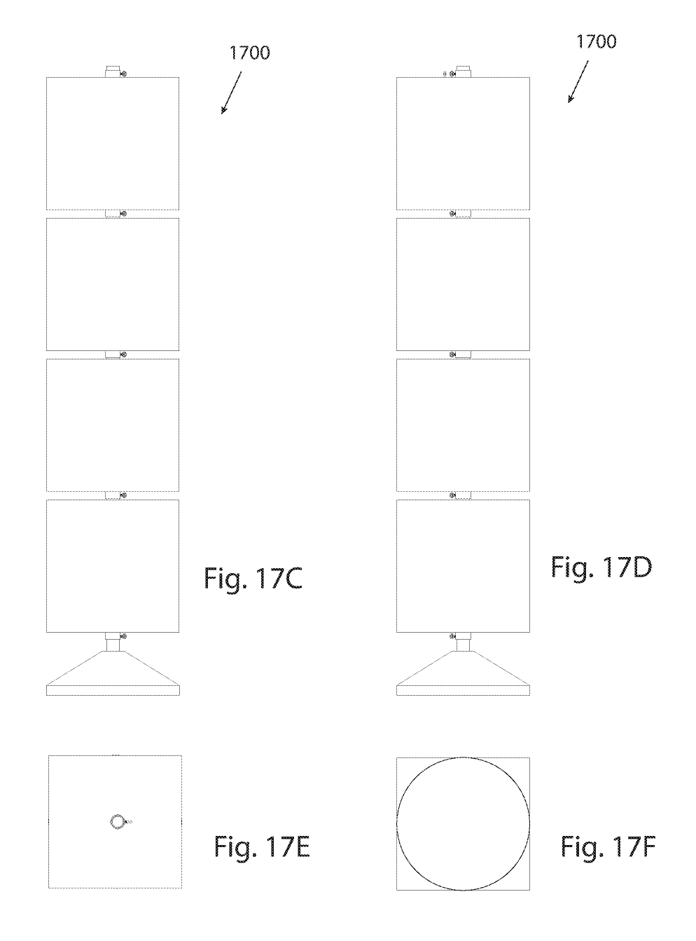

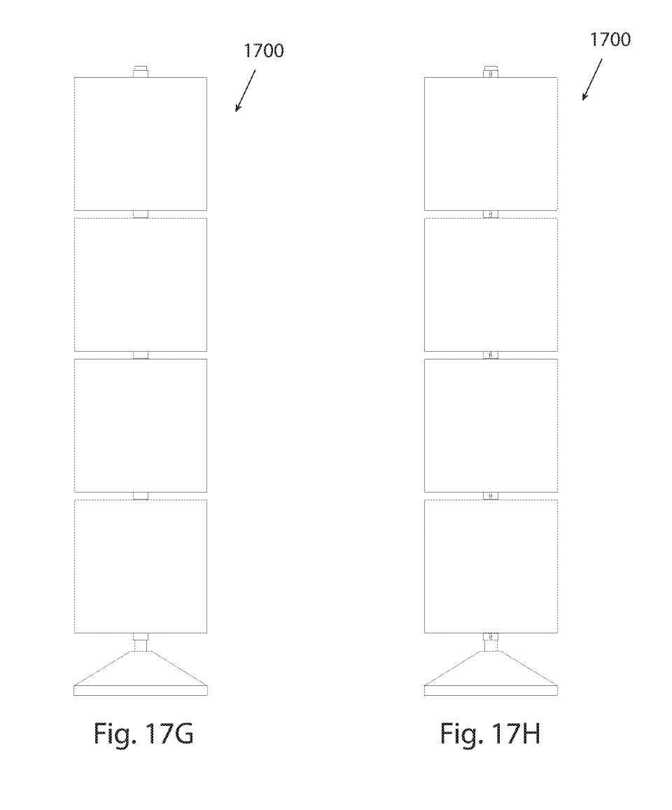

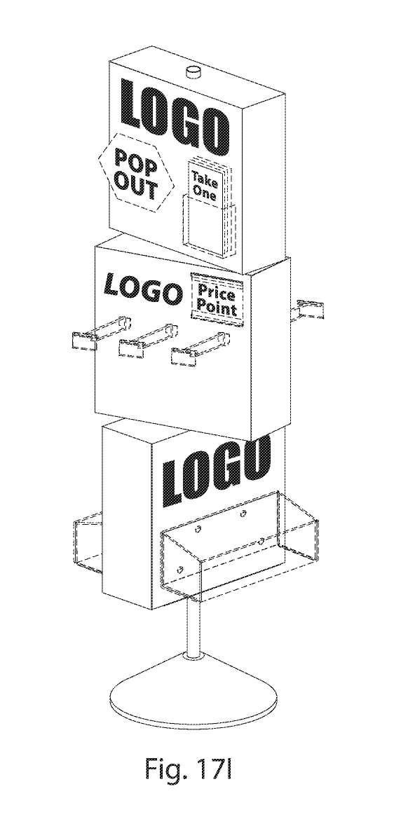

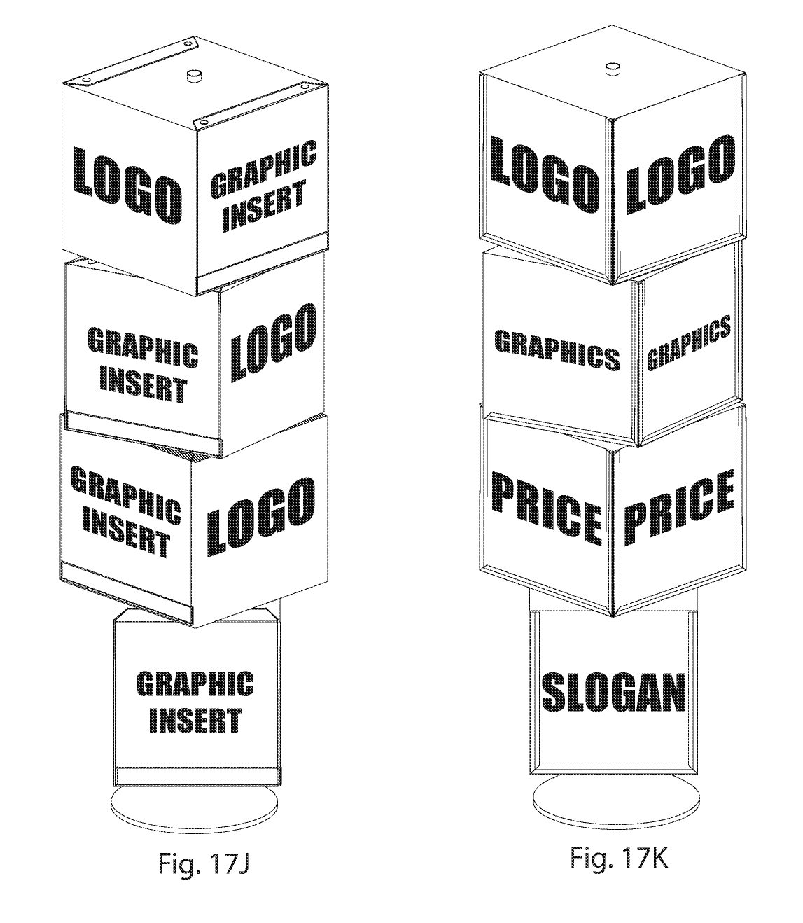

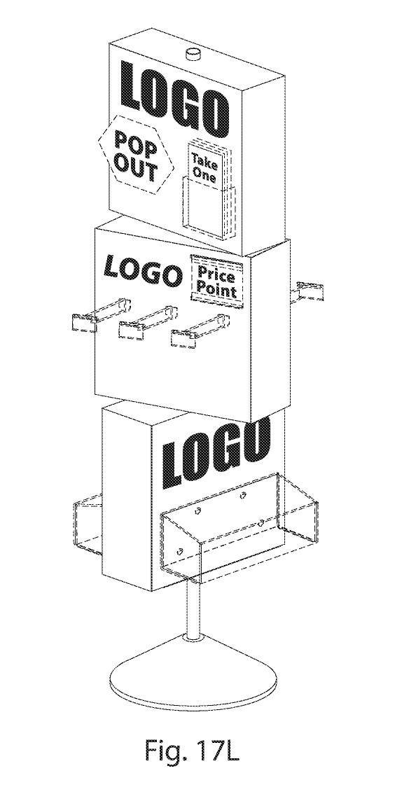

Turning to FIGS. 17A through 17H, a merchandising display structure in accordance with present teachings is illustrated and generally identified at reference character 1700. As shown, the merchandising display structure 1700 is self-supporting and includes a plurality of boxes 1702 that may independently rotate about a common axis. The merchandising display structure 1700 includes a support member 1704 for supporting the merchandising display structure 1700 on the floor.

With reference to FIGS. 17I through 17L, additional merchandising display structures similar to the merchandising display structure 1700 are shown. As illustrated, the boxes 1702 of the various merchandising display structures may be printed with graphics. The boxes 1702 may also carry brackets and/or shelves for the display of retail good.

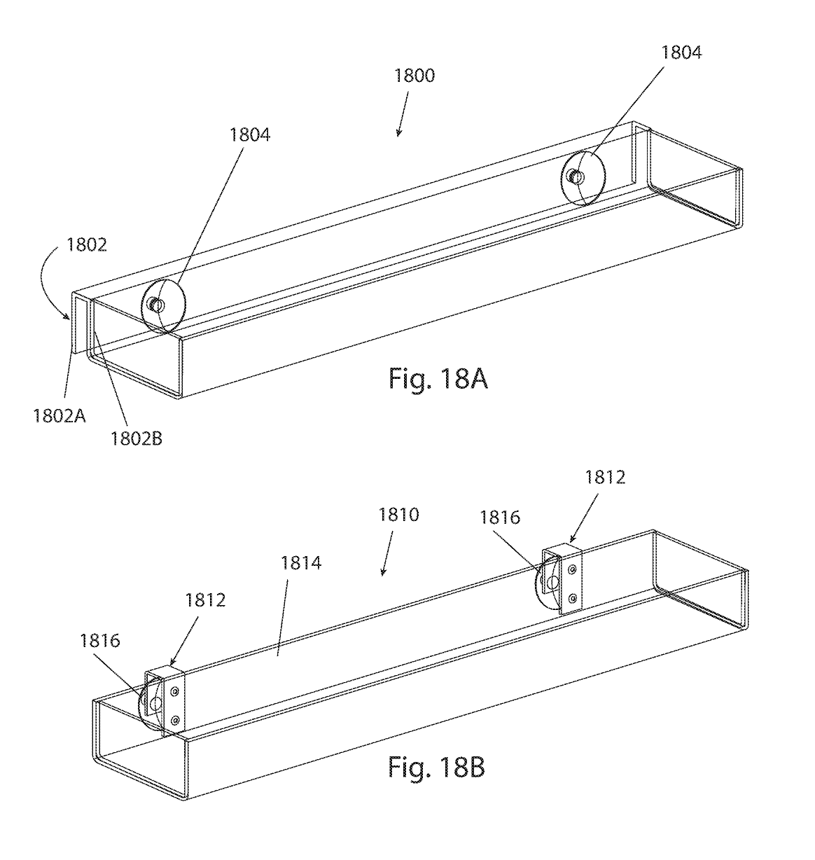

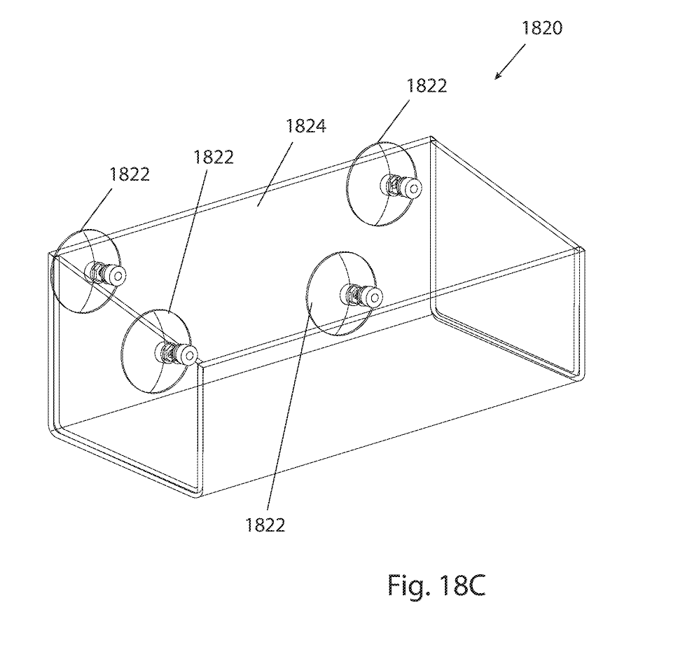

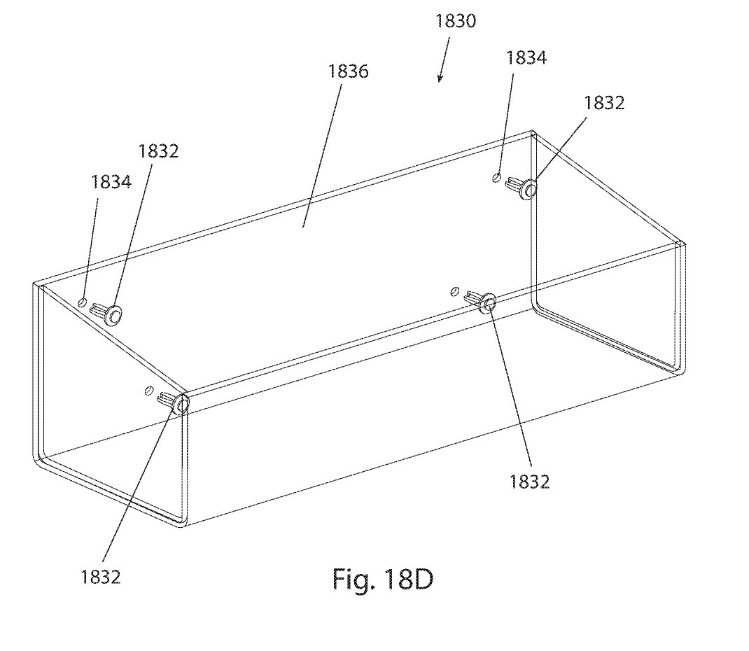

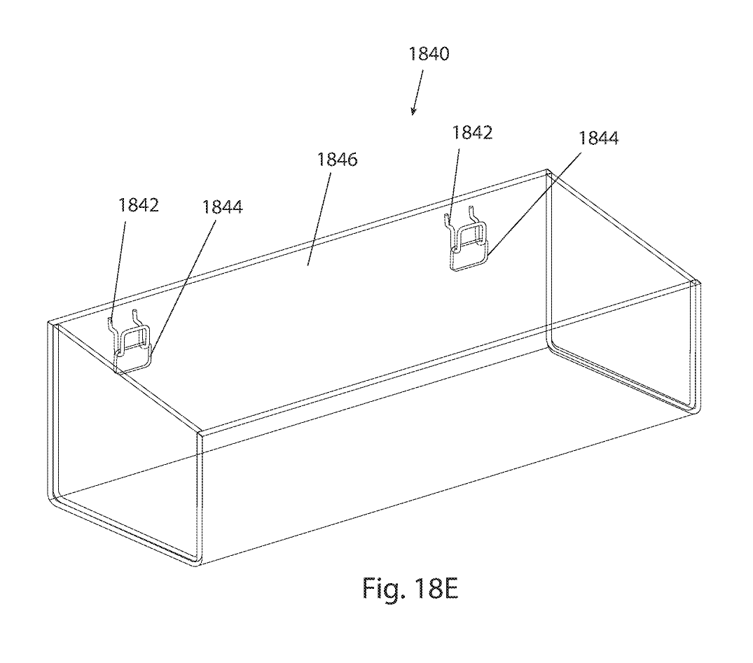

Turning to FIG. 18A is a bin for the display of retail goods in accordance with the present teachings is illustrated and generally identified at reference character 1800. In one particular application, the bin 1800 may be unitarily formed of an acrylic material. Other materials, however, may be used within the scope of the present teachings. The bin 1800 is generally rectangular in shape with an open upper side. The bin 1800 includes a generally U-shaped mounting portion 1802 running along a rear side thereof. The mounting portion 1802 may be used to attach the bin 1800 to a wall of a cooler, for example. The mounting portion includes first and second downwardly extending legs 1802A and 1802B. The first leg 1802A may carry one or more suction cups 1804 to prevent translation of the bin 1800. The second leg 1802B may define a rear wall of the bin 1800.

Turning to FIG. 18B is another bin for the display of retail goods in accordance with the present teachings is illustrated and generally identified at reference character 1810. As with the bin 1800, the bin 1810 may be formed of an acrylic or other material. The bin 1800 may be mounted to the wall of a cooler, for example, with a pair of brackets 1812. The brackets 1812 may be generally U-shaped. A first leg of each bracket 1812 may be secured to a rear wall 1814 of the bin 1810. A second leg of each bracket 1812 may be rearwardly spaced from the rear wall 1814 of the bin 1810 and may carry a suction cup 1816 to prevent translation of the bin 1810.

Turning to FIG. 18C is another bin for the display of retail goods in accordance with the present teachings is illustrated and generally identified at reference character 1820. As with the bin 1800, the bin 1820 may be formed of an acrylic or other material. The bin 1820 may be secured to a smooth surface with a plurality of suction cups 1822. The suction cups 1822 may be attached to the bin 1820 with fasteners that extend through holes in a rear wall 1824 of the bin.

Turning to FIG. 18D is another bin for the display of retail goods in accordance with the present teachings is illustrated and generally identified at reference character 1830. As with the bin 1800, the bin 1830 may be formed of an acrylic or other material. The bin 1830 may be secured to a support structure with a plurality of fasteners 1832. The fasteners 1832 may extend through holes 1834 in a rear wall 1836 of the bin.

Turning to FIG. 18E is another bin for the display of retail goods in accordance with the present teachings is illustrated and generally identified at reference character 1840. As with the bin 1800, the bin 1840 may be formed of an acrylic or other material. The bin 1840 may be secured to a support structure with a plurality of brackets 1842. The brackets 1842 may extend through holes 1844 in a rear wall 1846 of the bin.

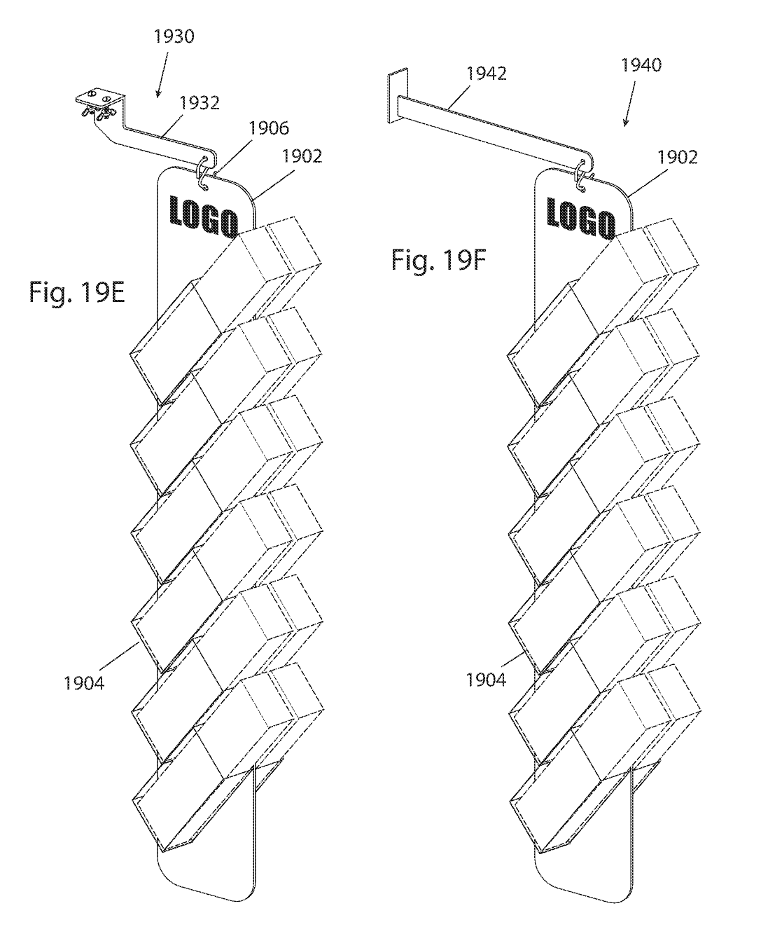

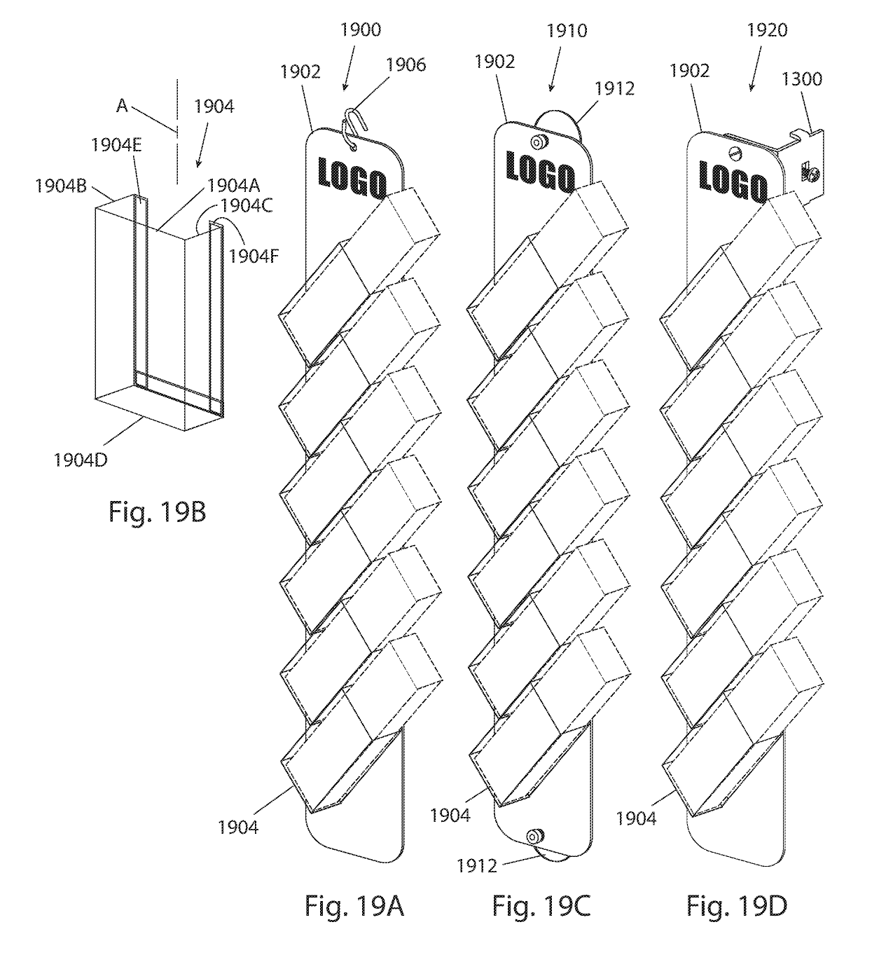

Turning to FIG. 19A, a merchandising display structure in accordance with the present teachings is shown and generally identified at reference character 1900. The merchandising display structure 1900 is shown to generally include a planar portion or panel 1902 and a plurality of product holders 1904. The panel 1902 may be constructed of cardboard or of any other suitable material. The panel 1902 may be pre-printed with graphics or graphics may be applied to the panel.

One of the product holders 1904 is shown in FIG. 19B removed from the panel 1902 for purposes of illustration. The product holder 1904 may be generally rectangular in shape and may be unitarily constructed of a clear, acrylic material. Other materials, however, may be used within the scope of the present teachings. In the embodiment illustrated, the product holder 1904 includes a front side 1904A, first and second lateral sides 1904B and 1904C, a closed end 1904D, an opposite open end 1904E and a rear side 1904F. The rear side 1904F may be defined by a pair of mounting flanges extending from a respective one of the first and second lateral sides 1904B and 1904C and otherwise be open.

The product holders 1904 may be secured to the panel 1902. For example, the mounting flanges of the rear side 1904F may be adhesively or otherwise suitable secured to the panel 1902. As shown, the product holders 1904 may be secured to the panel 1902 such that a longitudinal axis A of each holder 1904 is angled upwardly from the closed end 1904D to the open end 1904E. A hook 1906 may pass through a hole in the panel 1902 to suspend the merchandising display structure 1900.

Turning to FIGS. 19C through 19F, additional merchandising display structures similar to merchandising display structure 1900 are shown. In view of the similarities between these embodiments, like reference characters are used to identify like elements.

The merchandising display structure 1910 of FIG. 19C differs from the merchandising display structure 1900 by incorporating a pair of suction cups 1912 for attachment of the merchandising display structure 1910 to a smooth surface.

The merchandising display structure 1920 of FIG. 19D differs from the merchandising display structure 1900 by incorporating a bracket 1300 for engaging an upright of a gondola. The bracket 1300 may be similar to the bracket 1300 described above.

The merchandising display structure 1930 of FIG. 19E differs from the merchandising display structure 1900 by additionally incorporating mounting arm 1932 for attachment to the underside of a shelf. The merchandising display structure 1930 also includes product holders 1904 carried on both sides of the panel 1902.

The merchandising display structure 1940 of FIG. 19F differs from the merchandising display structure 1930 by incorporating an alternative mounting arm 1942.

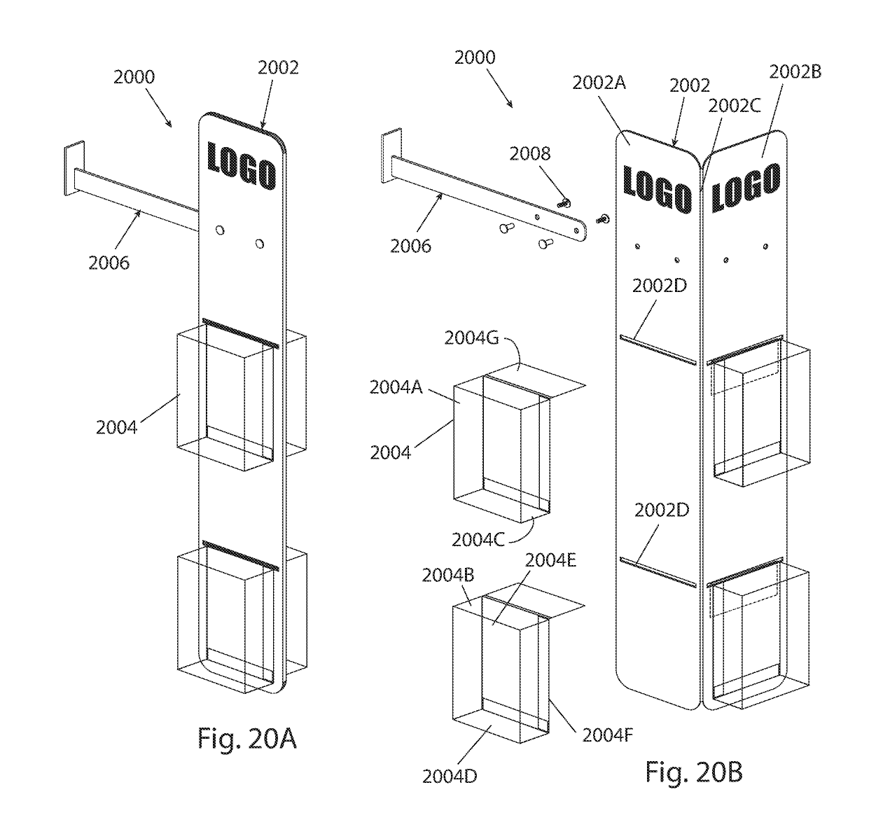

Turning to FIGS. 20A and 20B, a merchandising display structure in accordance with present teachings is illustrated and generally identified at reference character 2000. As shown, the merchandising display structure 2000 generally includes a panel 2002, a plurality of product holders 2004 and a mounting arm 2006.

The panel 2002 may be constructed of cardboard stock or any other suitable material. In the embodiment illustrated, the panel 2002 includes first and second panel halves 2002A and 2002B. The panel 2002 may be folded at a horizontally extending midline 2002C such that the first and second panel halves 2002A and 2002B are back to back. The panel 2002 may be printed with graphics or may carry graphics or product information.

The product holders 2004 may be generally rectangular in shape and may be constructed of any suitable material. In the embodiment illustrated, the product holder 2004 includes a front side 2004A, first and second lateral sides 20B and 20C, a closed end 2004D, an opposite open end 2004E and a rear side 2004F. The product holders 2004 may also include a tab 2004G extending from the rear side 2004F.

The product holders 2004 may be carried by the panel 2002. For example, the tabs 2004G may be inserted into corresponding slots 2002D of a respective one of the first and second panel halves 2002A and 2002B. The tabs 2004G may be folded down against a back of the respective first and second panel halves 2002A and 2002B after passing through the slot 2002D. In certain applications, it may be desirable to adhesively secure the tabs 2004G to the back of the respective first and second panel halves 2002A and 2002B. After all the product holders 2004 are engaged with a respective one of the first and second panel halves 2002A and 2002B in this manner, the panel 2002 may be folded in half. The folded panel 2002 may be secured to the mounting arm 2006 with fasteners 2008 or in any known manner.

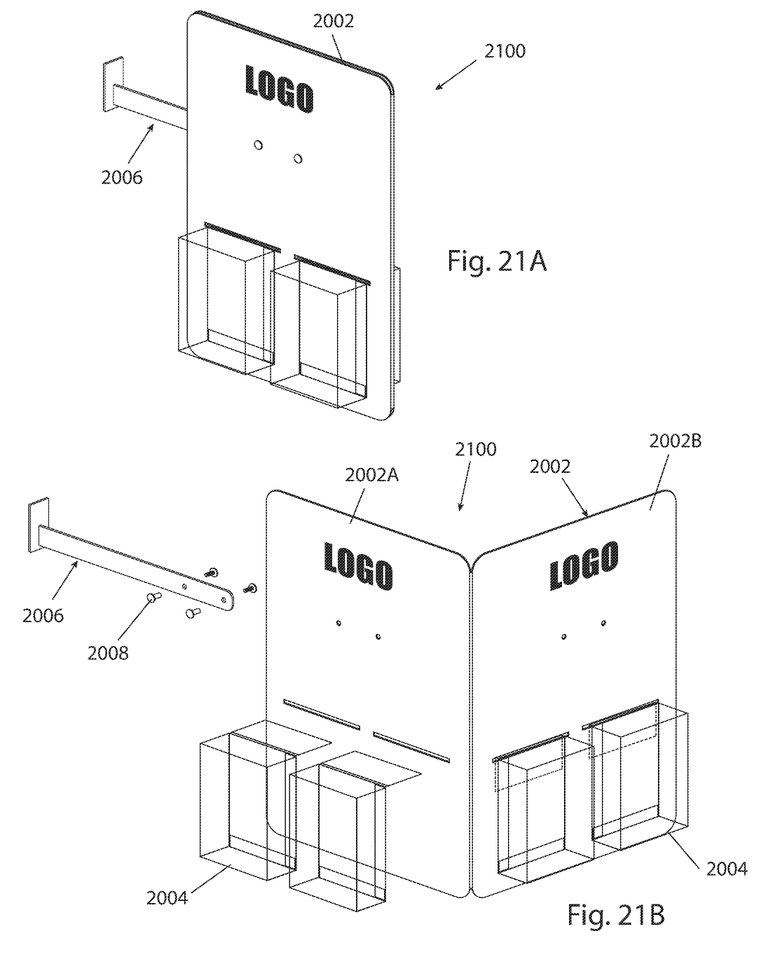

Turning to FIGS. 21A and 21B, a merchandising display system similar to the system 2000 is shown and generally identified at reference character 2100. In view of the similarities between these two embodiments, like reference characters are used to identify like elements.

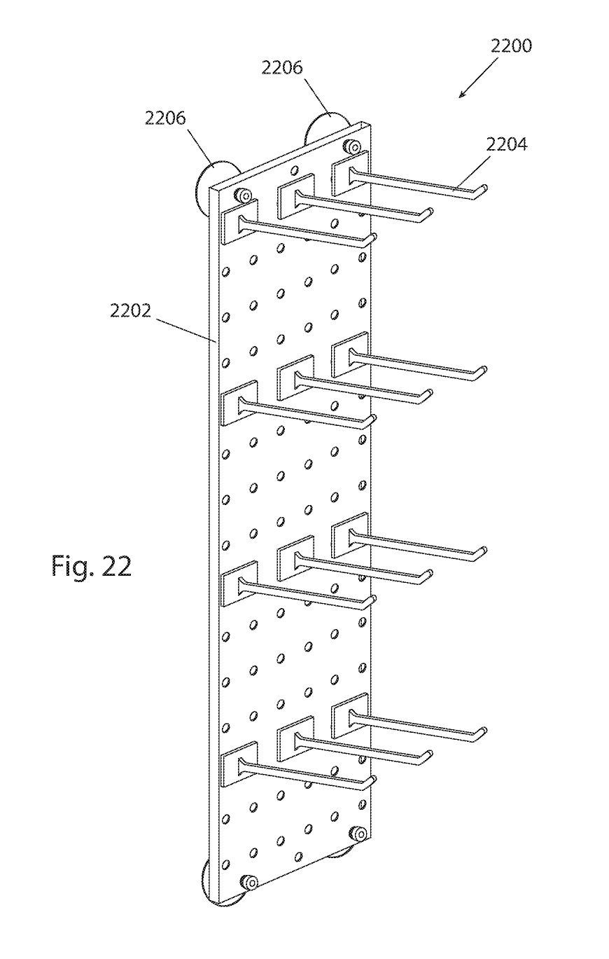

Turning to FIG. 22, another merchandising display system in accordance with the present teachings is shown and generally identified at reference character 2200. The system 2200 may include a panel 2202 and a plurality of hooks 2204. The panel 2202 may be constructed of any suitable material and may be solid or hollow. The panel 2202 may be formed to include a plurality of holes arranged in an array of rows and columns. The hooks 2204 may be conventional in constructions and may engage one or more of the holes in the panel to mount the hooks 2004 to the panel 2002. Retail product may be suspended from the hooks 2004 in a known manner. In the embodiment illustrated, the panel 2002 may be attached to a smooth surface with a plurality of suction cups 2206.

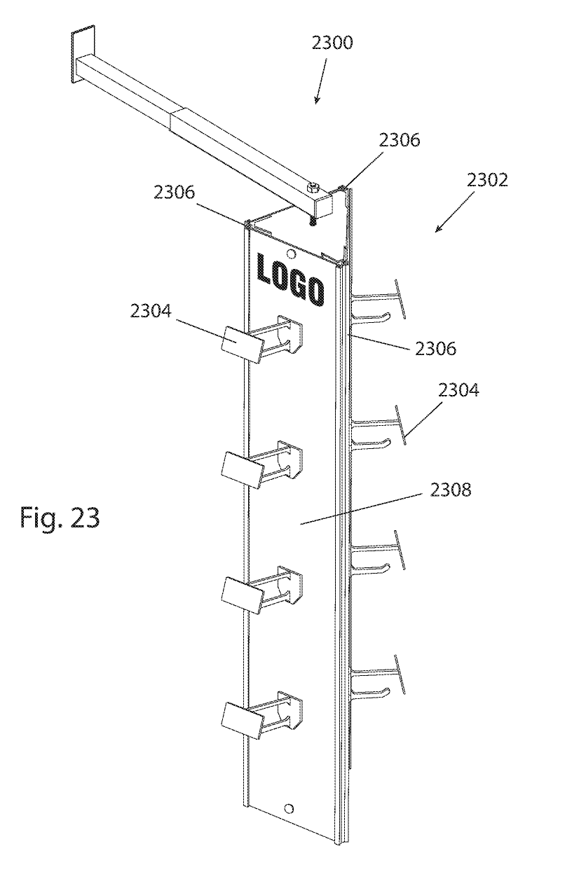

Turning to FIG. 23, another merchandising display system in accordance with the present teachings is shown and generally identified at reference character 2300. The system 2300 may include a main body portion 2302 and a plurality of product hangers 2304. The main body portion 2302 may have a generally triangular cross section in a horizontal plane and may include three connectors 2306 and three panels 2308. The connectors 2306 may run the length of the main body portion 2302 and may be substantially identical to one another. Each connector 2306 includes two sides each having a first portion or outer portion and a second portion or inner portion that cooperate with one another to define a channel for receiving a vertically extending edge of one of the panels 2308. The second portion is longer in a horizontal direction than the first portion. The two sides of each connector 2306 are angled relative to one another at an acute angle. In one application, the acute angle may be 80 degrees.

The product hangers 2304 may be carried by one of the panels 2308 in any manner known in the art. For example, the product hangers 2304 may be adhesively secured to one of the panels 2308. Alternatively, the panels 2308 may be provided with a plurality of holes that may be selectively engaged by the hangers in a manner known in the art. Retail product may be suspended from the hangers 2304 in a known manner.

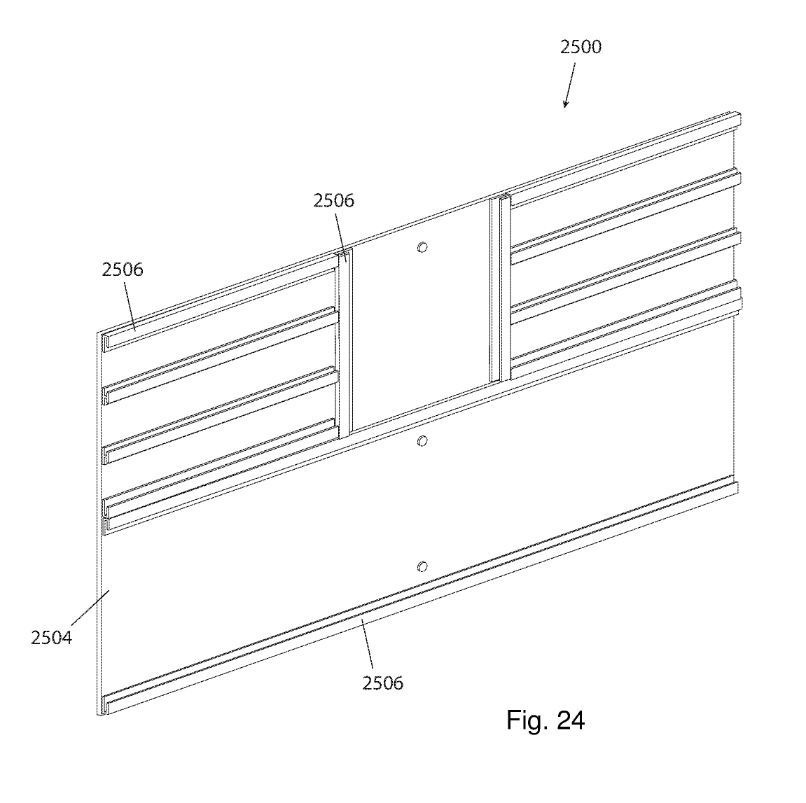

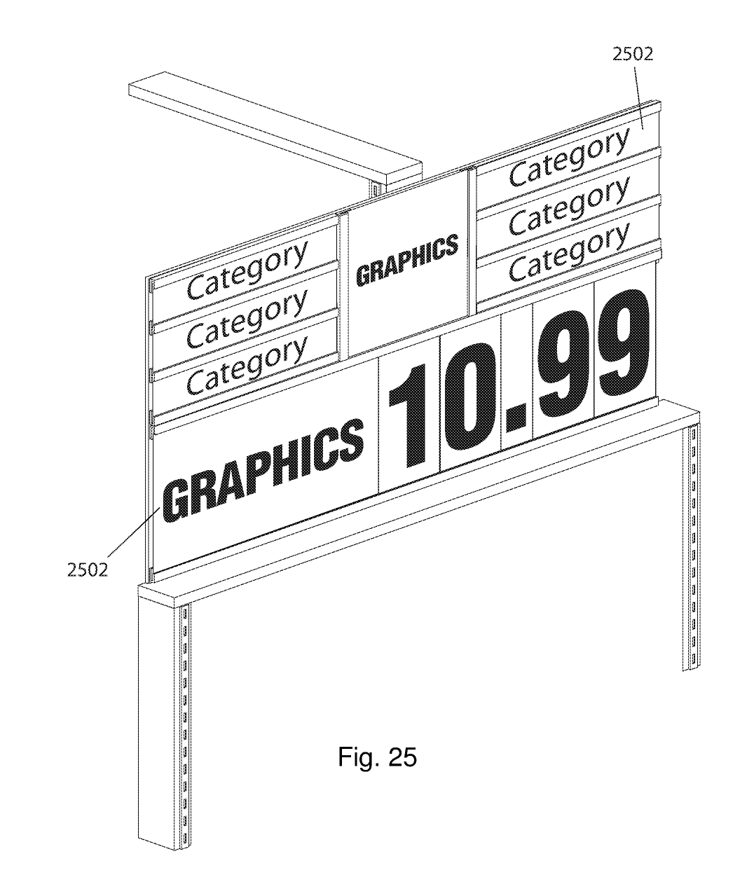

Turning to FIGS. 24 and 25, a sign holder in accordance with the present teachings is illustrated and generally identified at reference character 2500. The sign holder 2500 is adapted to receive a plurality of signs 2502. In the embodiment illustrated, the sign holder 2500 is shown to include a planar member 2504 and a plurality of channel members 2506. The channel members 2506 are U-shaped and define a channel for slidably receiving an edge of one of the signs 2502. The channel members 2506 may be adhesively or otherwise suitably attached to the planar member 2504. As shown, the channel members 2506 may be arranged in cooperating pairs and may be oriented horizontally or vertically. The channel members 2506 may extend fully or partially across the planar member 2504.

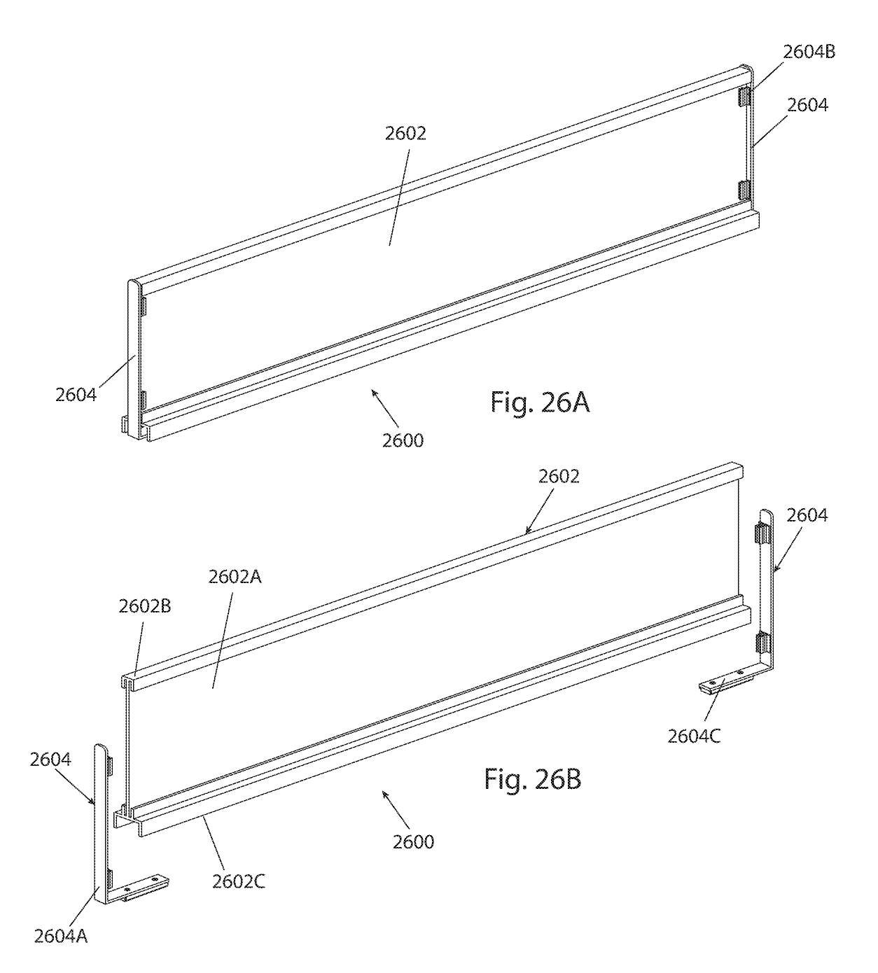

Turning to FIGS. 26A and 26B, a sign assembly in accordance with the present teachings is illustrated and generally identified at reference character 2600. The sign assembly 2600 is shown to generally include a sign holder 2602 and a pair of mounting members 2604.

The sign holder 2602 may be unitarily formed of plastic. Alternatively, the sign holder 2602 may be formed of multiple connected pieces of any suitable material. As illustrated, the sign holder 2602 includes a generally planar central portion 2602A, an upper portion 2602B, and a lower portion 2602C. In the embodiment illustrated, the generally planar central portion 2602A, the upper portion 2602B, and the lower portion 2602C extend the entire length of the sign holder 2602.

The upper portion 2602B is U-shaped having first and second downwardly ending legs subdivided by the generally planar central portion 2602A. Similarly, the lower portion 2602C is U-shaped and has first and second upwardly ending legs subdivided by the generally planar central portion 2602A. The legs of the upper portion 2602B and the lower portion 2602C each cooperate with the generally planar central portion 2602A to define a groove for receiving an edge of a sign. For example, a first sign having a shape similar to the generally planar central portion 2602A may be retained against a forward side of the generally planar central portion 2602A with a forward facing leg of the first and second downwardly ending legs of the upper portion 2602B and a rearwardly facing leg of the first and second downwardly ending legs of the upper portion 2602B.

The lower portion 2602C is shown to further including a U-shaped support portion including two downwardly extending legs. The support portion defines a channel that is open at both lateral ends of the sign holder 2602.

The mounting members 2604 will be understood to be substantially identical. As illustrated, each mounting member 2604 may include an L-shaped bracket 2604A. The bracket 2604A includes an upwardly extending leg and a horizontally extending leg. The upwardly extending leg may carry a pair of clips 2604B for engaging the generally planar central portion 2602A of the sign holder 2602. The horizontally extending leg may extend into the channel defined by the support portion of the lower portion 2602C of the sign holder 2602. A magnet 2604C may be mounted to the horizontally extending leg for attachment of the sign holder 2602 to a ferrous structure.

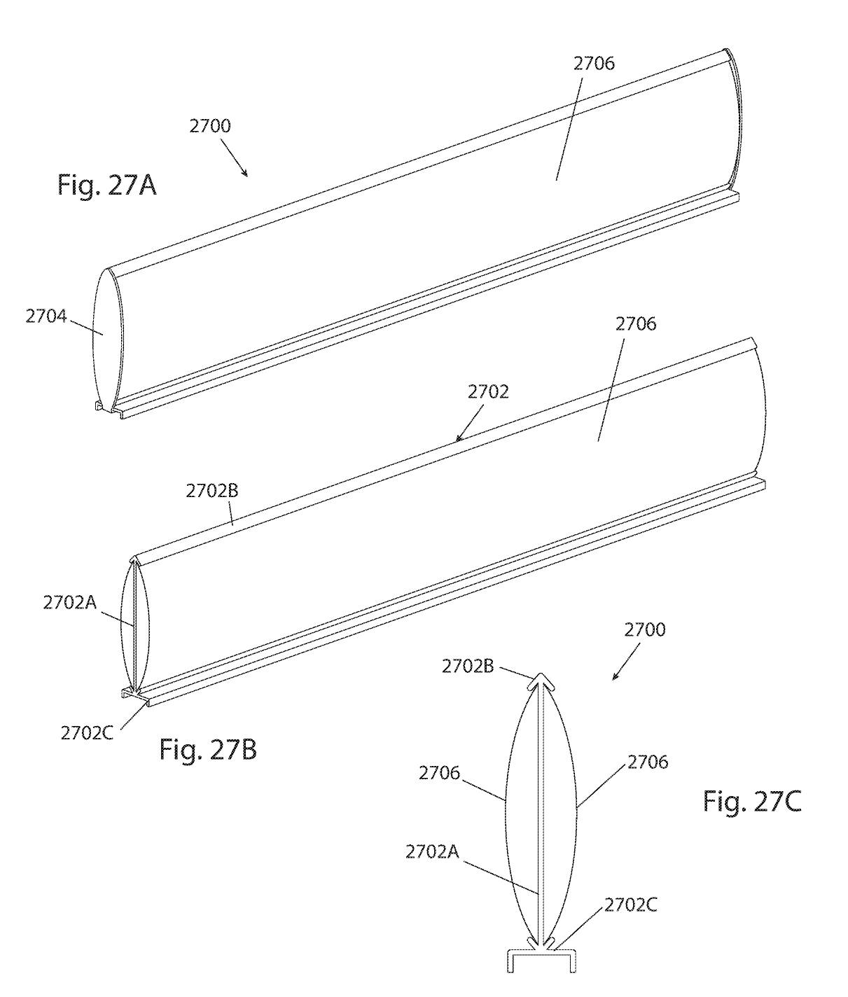

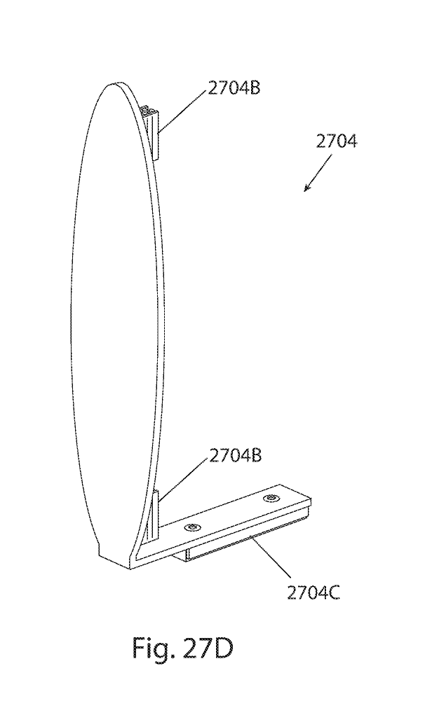

Turning to FIGS. 27A through 27D, another sign assembly in accordance with the present teachings is illustrated and generally identified at reference character 2700. The sign assembly 2700 is shown to generally include a sign holder 2702 and a pair of mounting members 2704. A pair of signs 2706 is shown carried by the sign holder 2702.

The sign holder 2702 may be unitarily formed of plastic. Alternatively, the sign holder 2702 may be formed of multiple connected pieces of any suitable material. As illustrated, the sign holder 2702 includes a generally planar central portion 2702A, an upper portion 2702B, and a lower portion 2702C. In the embodiment illustrated, the generally planar central portion 2702A, the upper portion 2702B, and the lower portion 2702C extend the entire length of the sign holder 2702.

The upper portion 2702B is generally V-shaped having first and second downwardly ending legs subdivided by the generally planar central portion 2702A. Similarly, the lower portion 2702C is generally V-shaped and has first and second upwardly ending legs subdivided by the generally planar central portion 2702A. The legs of the upper portion 27026 and the lower portion 2702C each cooperate with the generally planar central portion 2702A to define a groove for receiving an edge of a sign. For example, a first sign 2706 may be retained against a forward side of the generally planar central portion 2702A with a forward facing leg of the first and second downwardly ending legs of the upper portion 2702B and a rearwardly facing leg of the first and second downwardly ending legs of the upper portion 2702B. The first sign 2706 may have a length corresponding to the generally planar central portion 2702A and a height (in a planar state) greater than the height of the generally planar central portion 2702A such that the first sign 2706 bows when received by the sign holder 2702.

The lower portion 2702C is shown to further including a U-shaped support portion including two downwardly extending legs. The support portion defines a channel that is open at both lateral ends of the sign holder 2702.

The mounting members 2704 will be understood to be substantially identical. As illustrated, each mounting member 2704 may include an L-shaped bracket 2704A. The bracket 2704A includes an upwardly extending leg and a horizontally extending leg. The upwardly extending leg may carry a pair of clips 2704B for engaging the generally planar central portion 2702A of the sign holder 2702. The horizontally extending leg may extend into the channel defined by the support portion of the lower portion 2702C of the sign holder 2702. A magnet 2704C may be mounted to the horizontally extending leg for attachment of the sign holder 2702 to a ferrous structure.

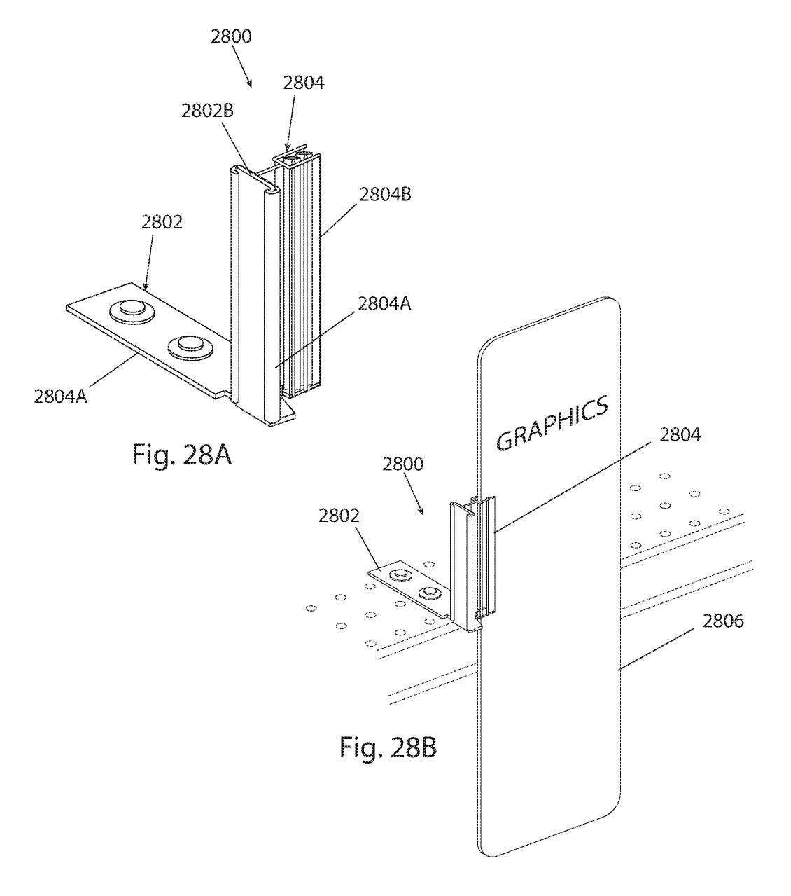

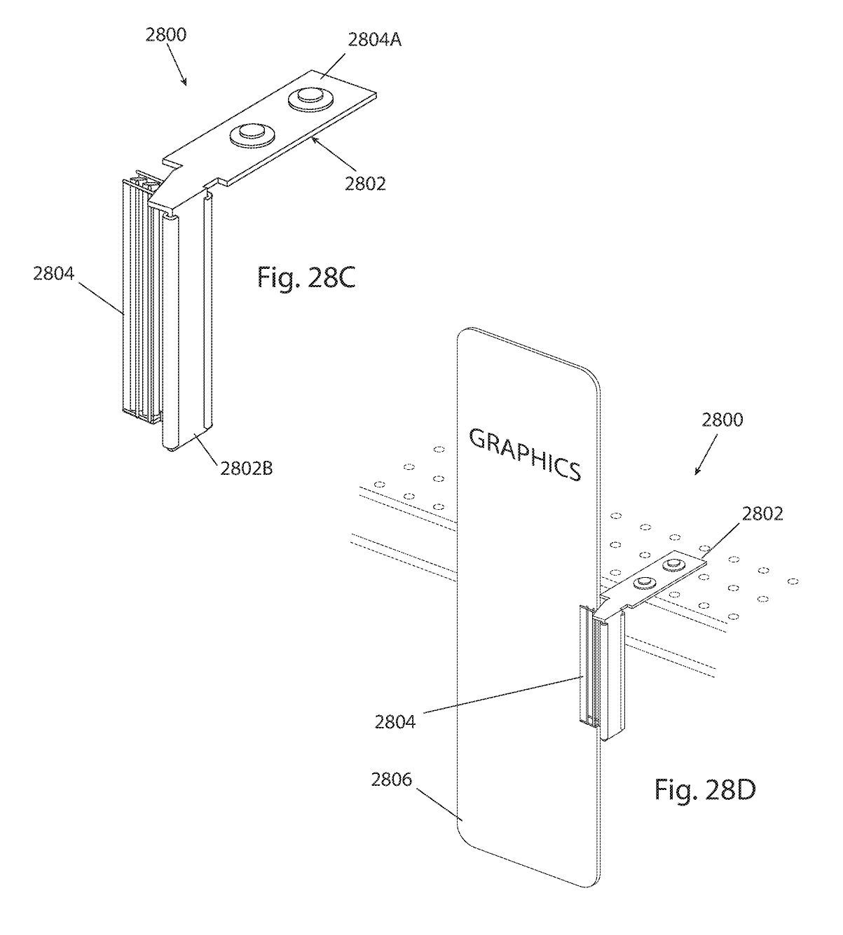

Turning to FIGS. 28A through 28D, a sign holder in accordance with the present teachings is illustrated and generally identified at reference character 2800. FIGS. 28A and 28B illustrate the sign holder 2800 in a first orientation. FIGS. 28C and 28D illustrate the sign holder 2800 in a second orientation.

The sign holder 2800 is illustrated to generally include a mounting member 2802 and a sign gripping member 2804. The mounting member 2802 includes a first generally planar portion 2802A and a second generally planar portion 2802B. The first generally planar portion 2802A may be mounted to a shelf, for example, with suitable fasteners. The second generally planar portion 2802B may extend perpendicular to the first generally planar portion 2802A.

The sign gripping member 2804 may include a first portion 2804A defining a channel for slidably receiving the second generally planar portion 2802B. The sign gripping member 2804 may additionally include a second portion 2804B for gripping a sign 2806. The sign gripping member 2804 may be unitarily formed of a flexible material capable of both gripping the sign 2806 and capable of deflecting the second portion 2804B relative to the first portion 2804A.

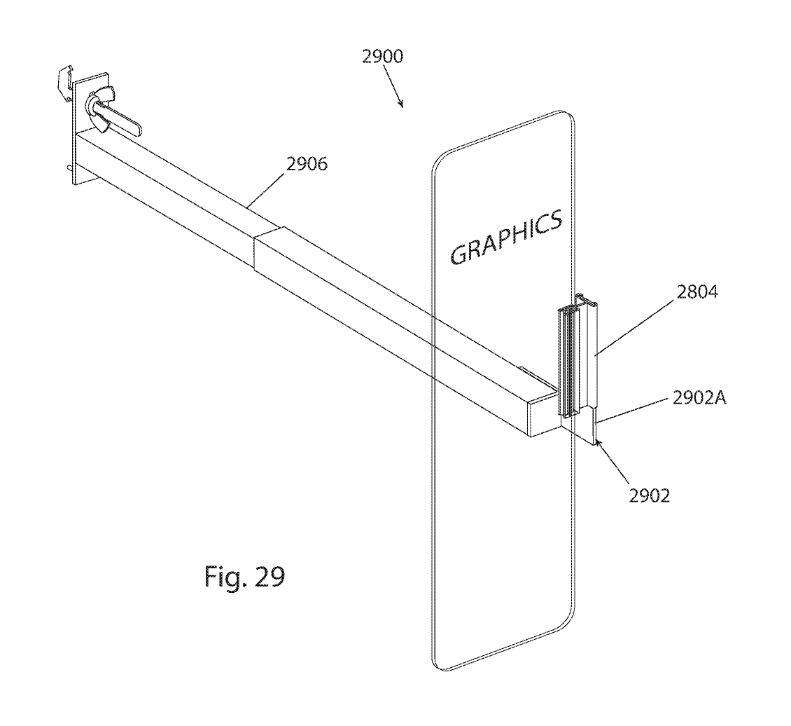

Turning to FIG. 29, another sign holder in accordance with the present teachings is illustrated and generally identified at reference character 2900. As with the sign holder 2800, the sign holder includes a mounting member 2902 and a sign gripping member 2804. The sign gripping member 2804 is identical to that described above. The mounting member 2902 includes a first generally planar portion 2902A and a second generally planar portion (not shown but identical to 2802B). The first generally planar portion 2902A is shown attached to an extendable arm 2906. The second generally planar portion is received by the sign gripping member 2804 in the manner discussed above.

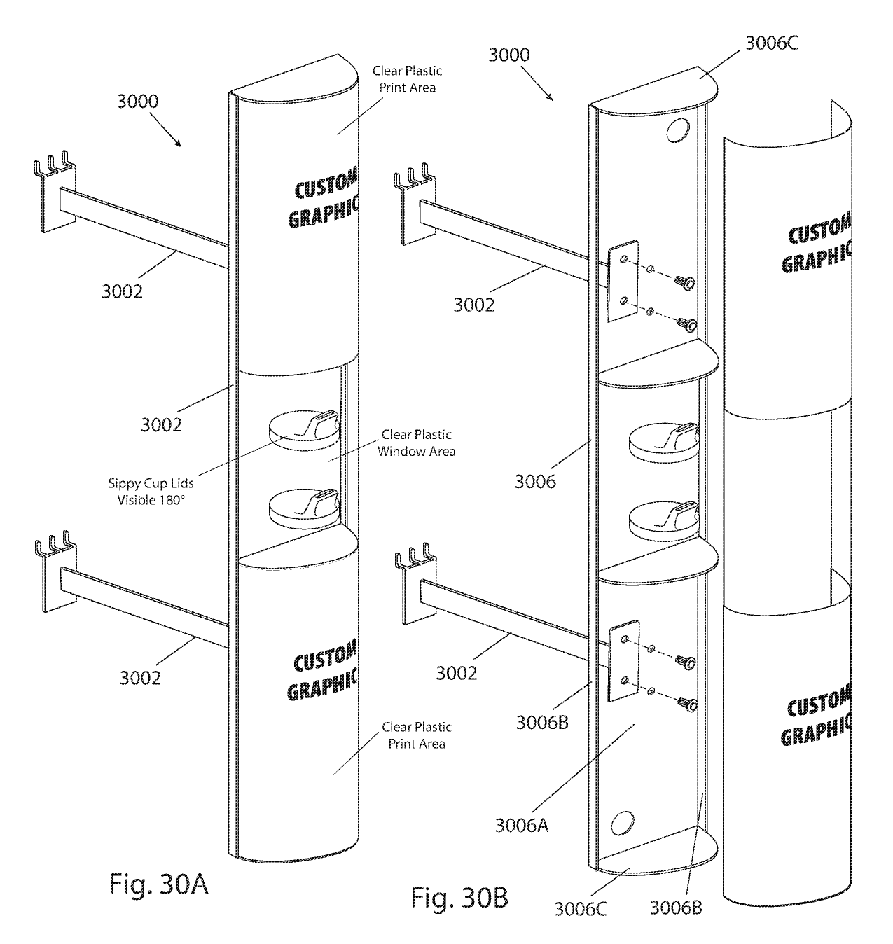

Turning to FIGS. 30A and 30B, another merchandising display structure in accordance with the present teachings is illustrated and generally identified at reference character 3000. As illustrated, the merchandising display structure 3000 may be connected with a gondola or other support structure with a pair of arms 3002. The merchandising display structure 3000 is shown to include a panel 3004. The panel 3004 may define a clear plastic window area and may be constructed of a flexible plastic material. In one application, the panel 3004 may be printed with graphics or may carry graphics or product information. Upon assembly, the panel 3004 may be curved in a horizontal direction.

The merchandising display structure 3000 may additionally include a frame 3006. The frame 3006 may generally include a planar back surface 3006A, a pair of laterally spaced flanges 3006B forwardly extending from the back surface 3006A, and upper and lower sides 3006C forwardly extending from the back surface 3006A. The back or rear surface 3006A may be secured to the arms 3002 with fasteners. The panel 3004 may be curved and retained by an inherent bias.

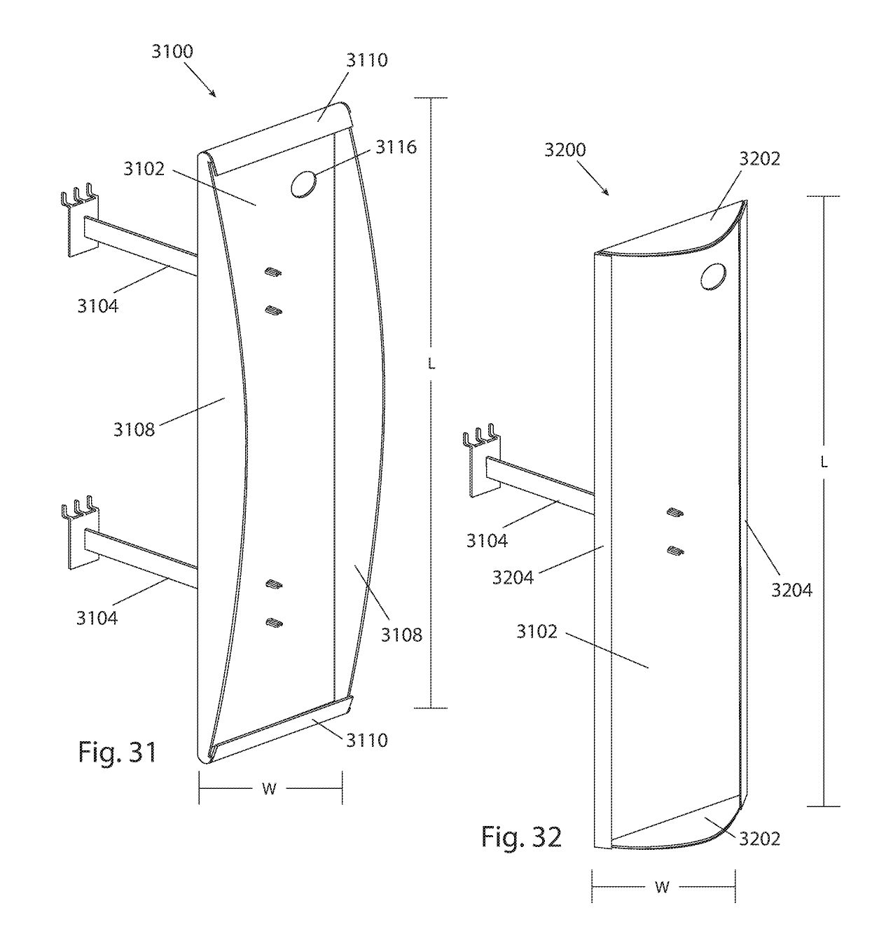

Turning to FIGS. 31 through 49, various sign holders in accordance with the present teachings are illustrated. Like reference numbers may be used to identify similar elements amongst these views. The sign holder of FIG. 31, which is generally identified at reference character 3100, may be unitarily constructed of plastic or other similar material. The sign holder 3100 may include a planar back panel 3102. The back panel 3102 may be provided with a plurality of apertures for receiving fasteners to attach the sign holder to a pair of arms 3104. The sign holder 3100 may be formed to include a larger hole 3106 in the back panel 3102 sized to receive a finger or thumb, the purpose of which will be described below.

The sign holder 3100 may include a length L and a width W. In the embodiment illustrated, the length is greater than the width. The sign holder 3100 may include a first pair of sides 3108 along the length L and a second pair of sides 3110 along the width W. As illustrated, the first pair of sides 3108 may be parallel to one another. Additionally, the edges of the first pair of sides 3108 may be convexly curved. The second pair of sides 3110 may extend upwardly and inwardly. Explaining further, the second pair of sides 3110 may each follow the convex curvature of the first pair of sides 3108.

The sign holder 3100 is adapted to receive a sign constructed of cardstock, plastic or other suitably flexible material and may be printed with graphics. The sign may have length slightly greater than a length of the inner side of the back panel 3102. In this manner, the sign may be attached to the sign holder 3100 by first inserting a first end of the sign into an upper portion an opening defined by the sides 3108 and 3110 and the back panel 3102. Next, the second end (e.g., the lower) of the sign may be inserted into the opening by elastically bending the sign to a curved shape. The sign may generally follow the convex curvature of the sides 3108. The hole 3106 may allow a user to remove the sign from the sign holder 3100 by poking out the sign from the back of the sign holder 3100.

Turning to FIG. 32, another sign holder in accordance with the present teachings is illustrated and generally identified at reference character 3200. As compared to the sign holder 3100, the sign holder 3200 includes planar sides 3202 at the top and bottom and curved sides 3204 that are laterally spaced apart along the length of the sign holder 3200. As such, a sign received by the sign holder 3200 will be curved from left to right, whereas the sign received by the sign holder 3100 will be curved from top to bottom. As illustrated, the sign holder 3200 may be mounted to a gondola or other support structure with a single arm 3104.

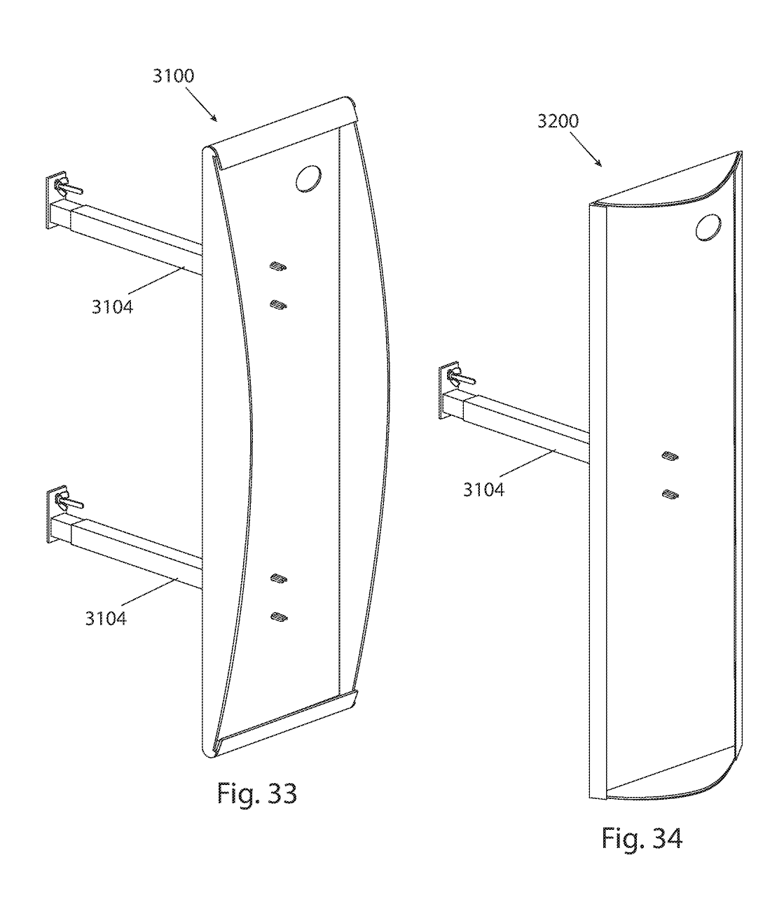

Turning to FIG. 33, the sign holder 3100 of FIG. 31 is shown with alternative mounting arms 3104′.

Turning to FIG. 34, the sign holder 3200 of FIG. 32 is shown with an alternative mounting arm 3104′.

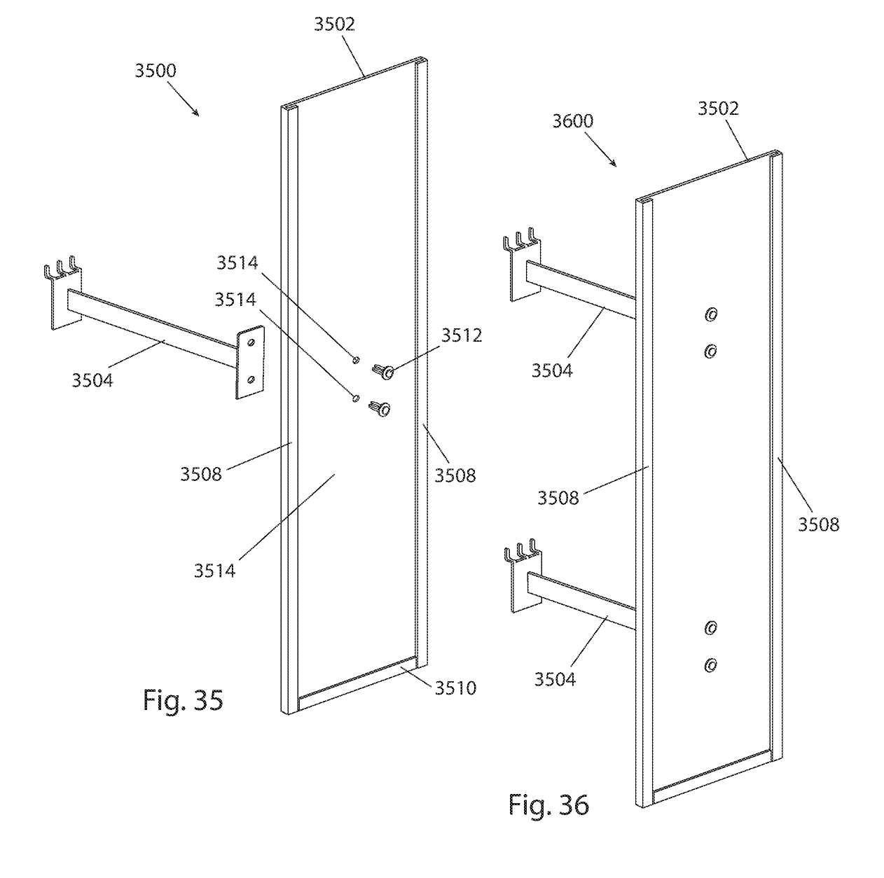

Turning to FIG. 35, another sign holder assembly in accordance with the present teachings is illustrated and generally identified at reference character 3500. The sign holder assembly 3500 is shown to generally include a sign holder 3502 and a mounting arm 3504. The sign holder 3502 may be integrally formed to include a planar portion 3506 and a pair of U-shaped sides 3508 laterally spaced apart and extending along the length of the sign holder 3502. The U-shaped sides 3508 may define grooves for slidably receiving a sign (not specifically shown). A bottom retaining member 3510 may be clipped to a lower end of the planar portion 3506 to prevent downward translation of the sign. Fasteners 3512 may pass through openings 3514 in the planar member 3502 for engagement with the arm 3504.

Turning to FIG. 36, another sign holder assembly in accordance with the present teachings is illustrated and generally identified at reference character 3600. The sign holder assembly 3600 is similar to the assembly 3500. For this reason, like reference characters are used to identify like elements. The assembly 3600 differs from the assembly 3500 in that it utilizes a pair of arms 3504.

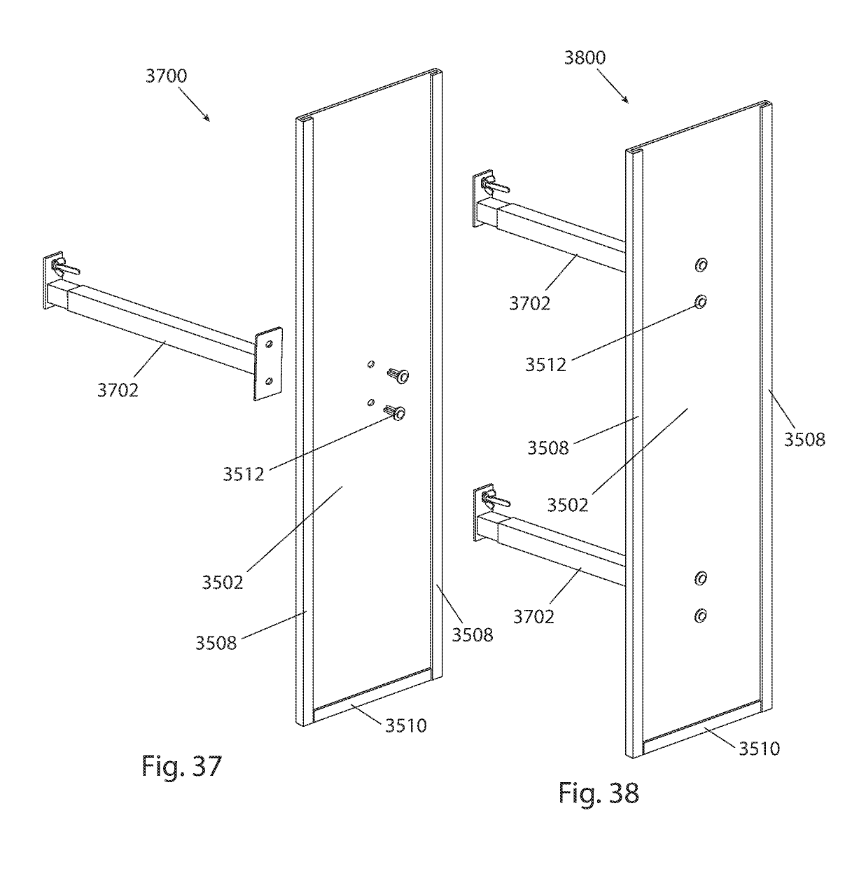

Turning to FIG. 37, another sign holder assembly in accordance with the present teachings is illustrated and generally identified at reference character 3700. Again, the sign holder assembly 3700 is similar to the assembly 3500 and like reference characters are used to identify like elements. The assembly 3700 differs from the assembly 3500 in that it utilizes an alternative mounting arm 3702.

Turning to FIG. 38, another sign holder assembly in accordance with the present teachings is illustrated and generally identified at reference character 3800. The sign holder assembly 3800 is similar to the assembly 3700 and like reference characters are used to identify like elements. The assembly 3800 differs from the assembly 3500 in that it utilizes a pair of mounting arm 3702.

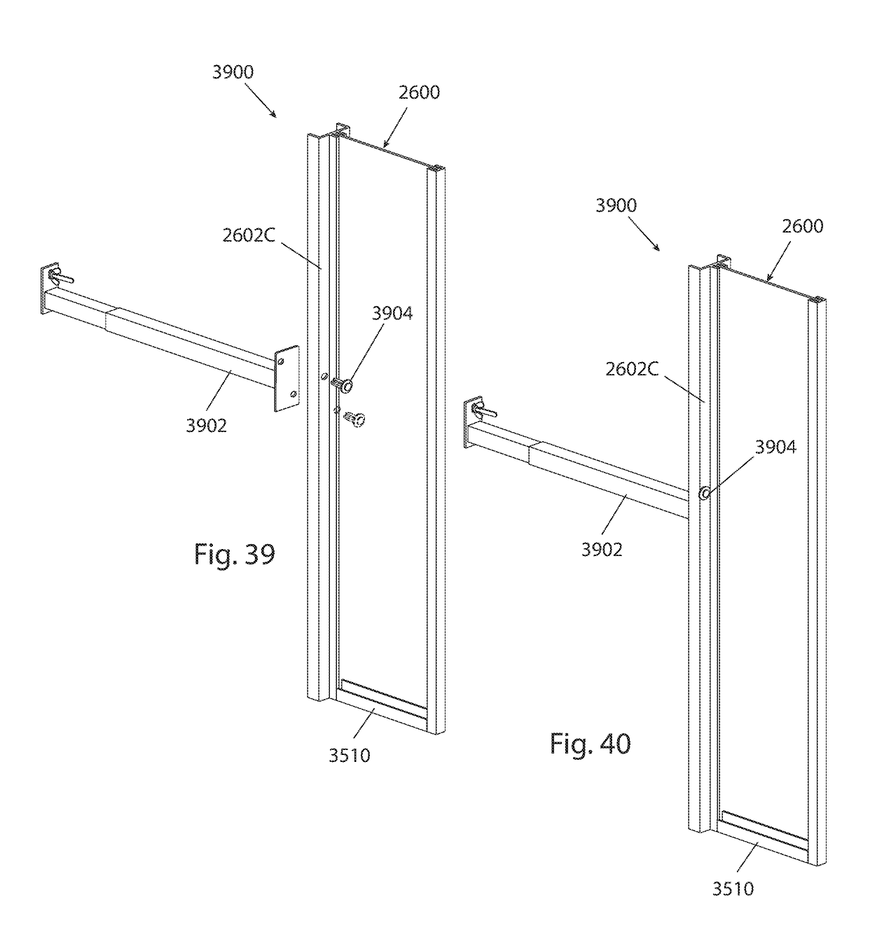

Turning to FIGS. 39 and 40, another sign holder assembly in accordance with the present teachings is illustrated and generally identified at reference character 3900. The sign holder assembly 3900 is illustrated to generally include the sign holder 2600 of FIGS. 26A and 26B and a mounting arm 3900. One or more fasteners 3904 may extend through the U-shaped portion 2602C to connect the sign holder 2600 with the mounting arm 3902. In view of the orientation of the sign holder 2600, the assembly 3900 may additionally incorporate the bottom retaining member 3510 of FIG. 35.

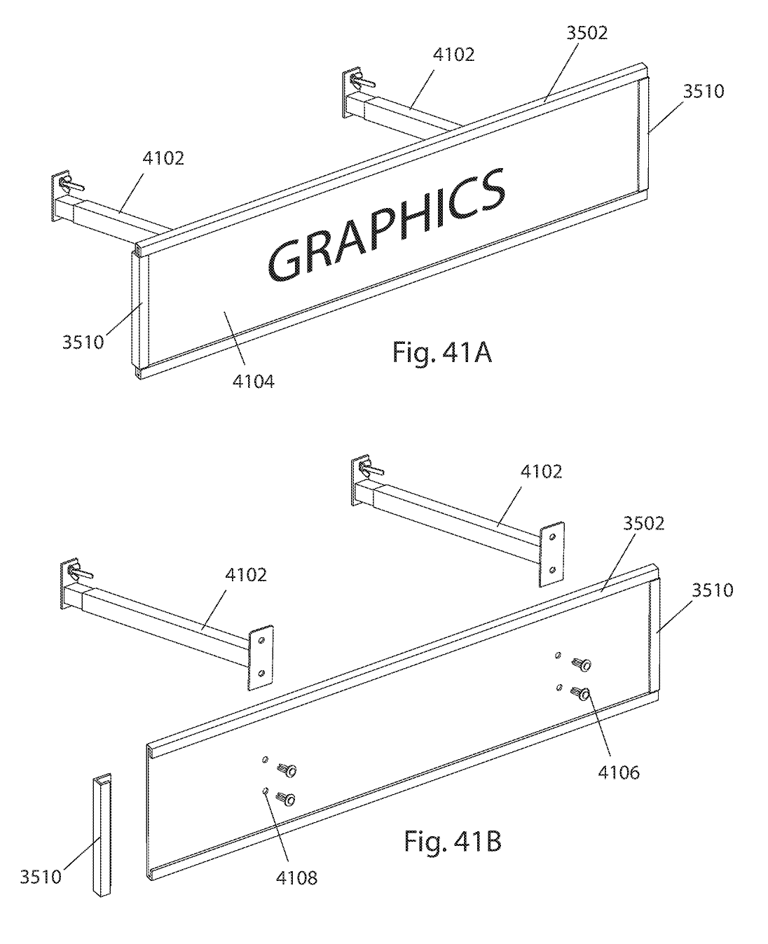

Turning to FIGS. 41A and 41B, another sign holder assembly in accordance with the present teachings is illustrated and generally identified at reference character 4100. The sign holder assembly 4100 is shown to generally include the sign holder 3502 of FIGS. 35 and 36 and a pair of mounting arms 4102. In FIG. 41A, the sign holder 3502 is shown operatively associated with a sign 4104. Fasteners 4106 may extend through holes 4108 in the sign holder 3502 and engage the mounting arm 4102. The assembly 4100 may incorporate a pair of retaining members 3510.

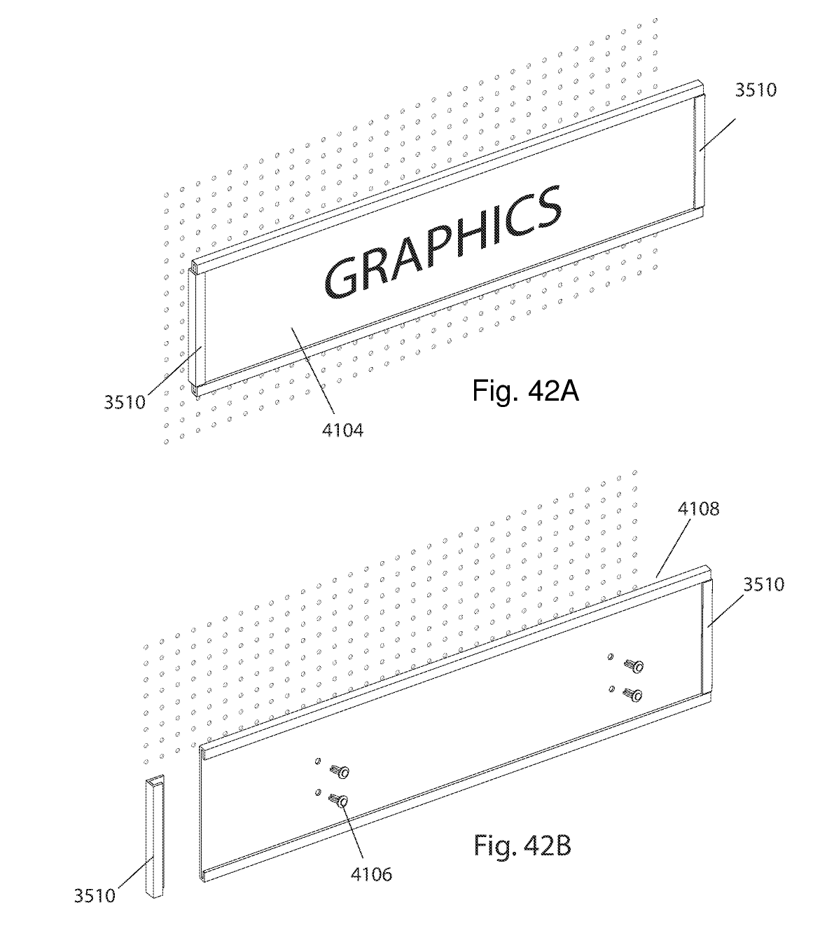

Turning to FIGS. 42A and 42B, another sign holder assembly in accordance with the present teachings is illustrated and generally identified at reference character 4200. The sign holder assembly 4200 is again shown to generally include the sign holder 3502 of FIGS. 35 and 36. In this embodiment, the sign holder 3502 is alternatively mounted to a gondola. Fasteners 4106 may extend through holes 4108 in the sign holder 3502 for mounting to the gondola. The assembly 4200 may incorporate a pair of retaining members 3510.

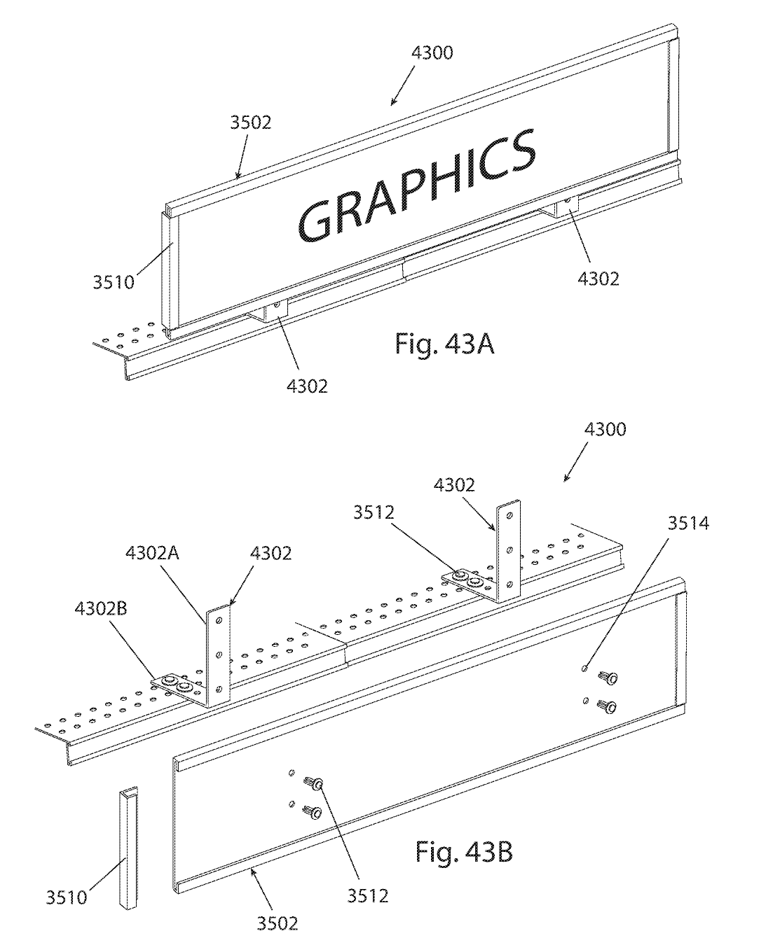

Turning to FIG. 43, another sign holder assembly in accordance with the present teachings is illustrated and generally identified at reference character 4300. The sign holder assembly 4300 is again shown to generally include the sign holder 3502 of FIGS. 35 and 36. In this embodiment, the sign holder 3502 is alternatively mounted to a shelf with a pair of brackets 4302. The brackets 4302 may be L-shaped having an upwardly extending portion 4302A and a horizontally extending portion 4302B. Fasteners 4106 may extend through holes 4108 in the sign holder 3502 for mounting to the upwardly extending portions 4302A of the brackets 4302. The horizontally extending portions 4302B may be secured to the shelf with fasteners 3512.

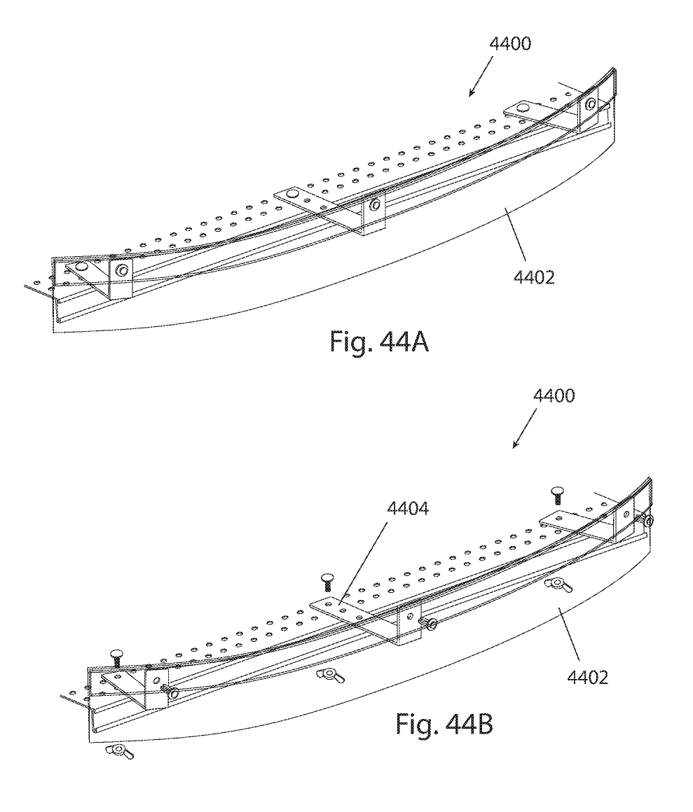

Turning to FIGS. 44A and 44B, another sign holder in assembly accordance with the present teachings is illustrated and generally identified at reference character 4400. The assembly 4400 is generally shown to include a sign holder 4402 and a plurality of mounting brackets 4404 for attachment to a shelf, for example. The brackets 4404 may be sized and configured to convexly curve the sign holder 4402.

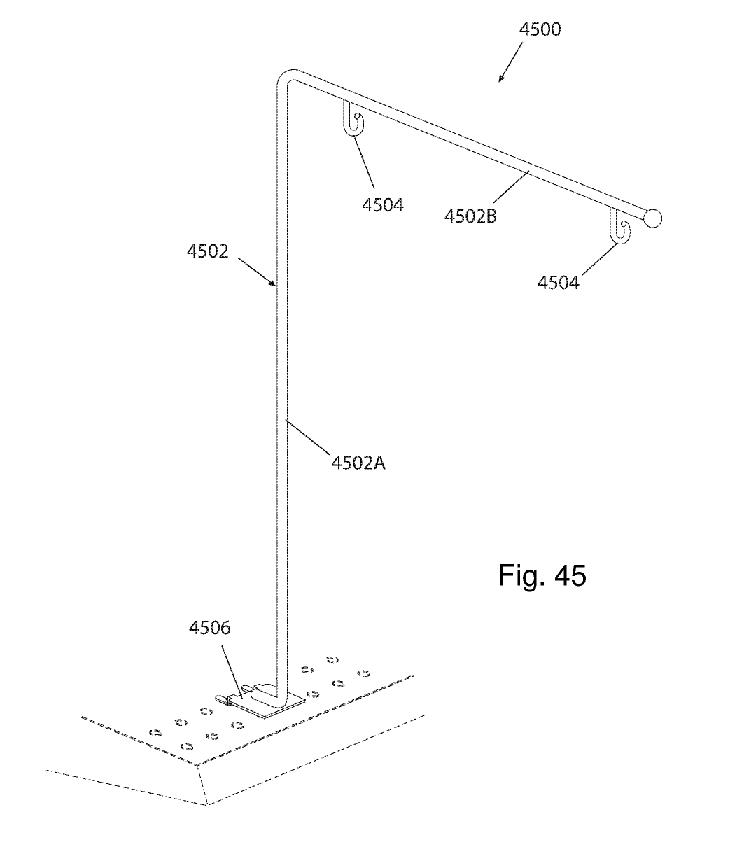

Turning to FIG. 45, another sign holder in accordance with the present teachings is illustrated and generally identified at reference character 4500. The sign holder 4500 is shown to generally include a cylindrical member 4502 configured to have a horizontally extending portion 4502A and a vertically extending portion 4502B. A pair of hooks 4504 for suspending a sign may be welded or otherwise secured to the horizontally extending portion 4502A. A mounting portion 4506 may be welded or otherwise secured to the vertically extending portion 4502B.

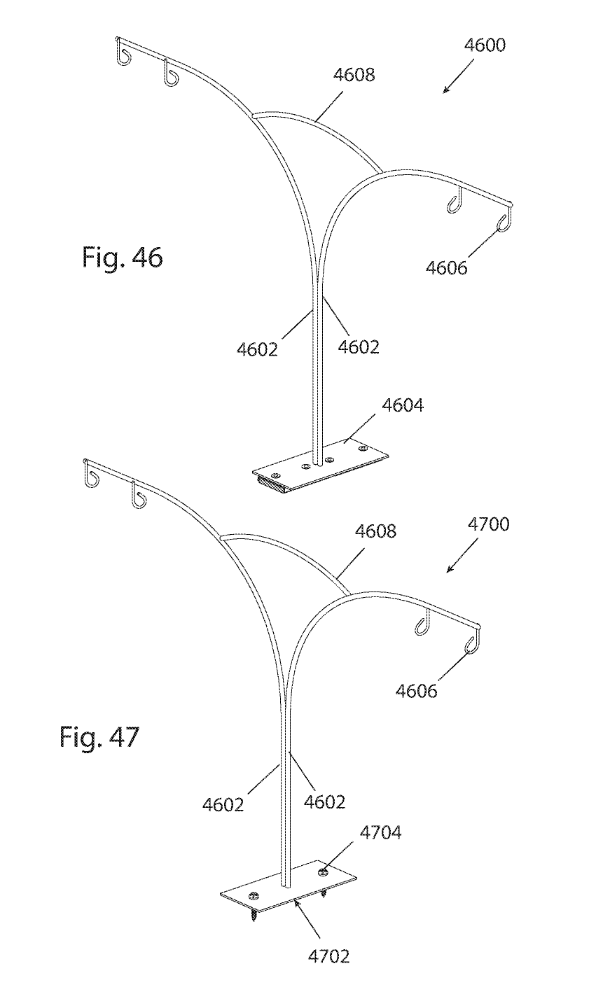

Turning to FIG. 46, another sign holder in accordance with the present teachings is illustrated and generally identified at reference character 4600. The sign holder 4600 may be for an overhead signage system. The sign holder may include a pair of wire arms arm 4602. The wire arms 4602 may be secured at their lower ends to one another and to a C-shaped member mounting portion 4604. The mounting portion 4604 may include a magnet. The wire arms 4602 may be welded or otherwise permanently or removably secured to the mounting member 4604. The arms 4602 may be arcuate in shape. Ends of the arms 4602 may each carry one or more hooks 4606 for supporting a sign. The arcuate arms 4602 may be braced by a bracing member 4608. A generally v-shaped opening may be defined between the arcuate arms 4602 and the bracing member 4608. As illustrated, the bracing member 4608 may be arcuate.

Turning to FIG. 47, another sign holder in accordance with the present teachings is illustrated and generally identified at reference character 4700. The sign holder 4700 is similar to the sign holder 4600. The sign holder 4700 may differ from the sign holder 4600 by incorporating an alternative mounting member 4702. The mounting member 4702 may be secured to a support structure with a plurality of fasteners 4704, for example.

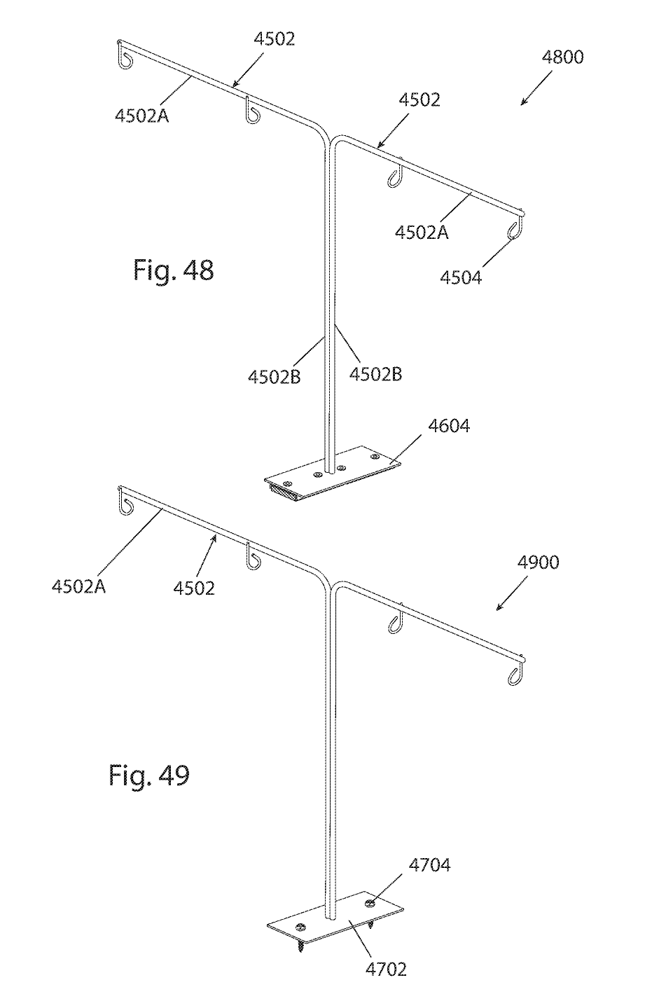

Turning to FIG. 48, another sign holder in accordance with the present teachings is illustrated and generally identified at reference character 4800. The sign holder 4800 is shown to generally include a pair of cylindrical members 4502 each configured to have a horizontally extending portion 4502A and a vertically extending portion 4502B. A pair of hooks 4504 for suspending a sign may be welded or otherwise secured to each of the horizontally extending portion 4502A. A mounting portion 4604 may be welded or otherwise secured to the vertically extending portions 4502B. The vertically extending portions 4502B may be welded or alternatively attached to one another.

Turning to FIG. 49, another sign holder in accordance with the present teachings is illustrated and generally identified at reference character 4900. The sign holder 4900 is similar to the sign holder 4800. The sign holder 4900 may differ from the sign holder 4800 by incorporating an alternative mounting member 4702. The mounting member 4702 may be secured to a support structure with a plurality of fasteners 4704, for example.

While specific examples and alternatives have been described in the specification and illustrated in the drawings, it will be understood by those skilled in the art that various further changes may be made by and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

1. A shelf bracket for suspending merchandising display structures, the shelf bracket comprising:
a generally planar main body portion;
a proximal end for attachment to a shelf; and
a distal end for suspending a merchandising display structure, the distal end defining at least one opening; and
a first tab extending into a first opening of the at least one opening for engaging a hole in a mounting tab of a first merchandising display structure.

2. The shelf bracket of claim 1, wherein the distal end is formed to include first and second openings.

3. The shelf bracket of claim 2, wherein the distal end includes a web between the first and second openings.

4. The shelf bracket of claim 3, further comprising a second tab extending into the second opening.

5. The shelf bracket of claim 4, wherein the first and second tabs extend from the web.

6. The shelf bracket of claim 5, wherein the first and second tabs both include a maximum width portion and a reduced width portion, the reduced width portion positioned closer to the web.

7. The shelf bracket of claim 1, in combination with the first merchandising display, the first tab extending through the hole in mounting tab.

8. The shelf bracket of claim 4, in combination with the first merchandising display and a second merchandising display structure, the first tab extending through the hole in mounting tab of the first merchandise display structure and the second tab extending through a hole in a second mounting tab of a second merchandising display structure.

9. (canceled)

10. (canceled)

11. (canceled)

12. A shelf bracket for suspending merchandising display structures, the shelf bracket comprising:
a generally planar main body portion elongated along an axis of elongation, the generally planar main body portion including a proximal end for attachment to a shelf, and a distal end for suspending a merchandising display structure, the distal end defining first and second openings extending parallel to each other, the first and second openings separated from each other by a web of the generally planar main body portion; and
a first tab extending in a first tab direction from the web into the first opening and a second tab extending from the web in a second tab direction into the second opening, the first and second directions being opposite directions, the first and second tabs for engaging a hole in a mounting tab a first merchandising display structure and a second merchandising display structure, respectively.

13. The shelf bracket of claim 12, wherein the first and second tabs both include a maximum width portion and a reduced width portion, the reduced width portion positioned closer to the web than the maximum width portion.

14. The shelf bracket of claim 12, in combination with the first and second merchandising display structures, the first tab extending through the hole in the first mounting tab, the second tab extending through the hole in the second mounting tab.
